(19) United States
(12) Patent Application Publication
(10) Pub. No.: US 2026/0059119 A1
(43) Pub. Date: Feb. 26, 2026

(54) IMAGE DATA CONTROL STORAGE UNIT WITH SLICE INFORMATION

(71) Applicant: QUALCOMM Incorporated, San Diego, CA (US)

(72) Inventors: Yoonjung KIM, Gyeonggi-do (KR); Woo Young KIM, Seongnam-si (KR); Jinmo KWON, Seoul (KR); Dong-Kyu LEE, Seoul (KR)

(21) Appl. No.: 18/811,271

(22) Filed: Aug. 21, 2024

(51) Int. Cl. H04N 19/174; H04N 19/423; H04N 19/70; H04N 19/96

(52) U.S. Cl. CPC H04N 19/174; H04N 19/423; H04N 19/70; H04N 19/96

(57) ABSTRACT

A device includes a first memory configured to include a control storage unit associated with an image frame. The device also includes a processor configured to receive a bitstream representing multiple tiles of the image frame. Each of the multiple tiles includes a plurality of tile rows of coding units. The processor is also configured to, for a tile row of a tile of the multiple tiles, generate a control entry of the control storage unit. The control entry includes tile row information that indicates a slice identifier of a slice that includes at least a portion of the tile row.

### FIELD

The present disclosure is generally related to decoding image data.

### DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive image data. For example, the image data may represent an encoded video stream. Such devices may include a decoder that decodes an image frame and outputs the image frame to a display device. Outputting decoded image portions, as compared to an entire image, can reduce display latency and improve user experience.

### SUMMARY

According to one implementation of the present disclosure, a device includes a first memory configured to include a control storage unit associated with an image frame. The device also includes a processor configured to receive a bitstream representing multiple tiles of the image frame. Each of the multiple tiles includes a plurality of tile rows of coding units. The processor is also configured to, for a tile row of a tile of the multiple tiles, generate a control entry of the control storage unit. The control entry includes tile row information that indicates a slice identifier of a slice that includes at least a portion of the tile row.

According to another implementation of the present disclosure, a device includes a first memory configured to include a control storage unit associated with an image frame that includes multiple tiles. Each of the multiple tiles includes a plurality of tile rows of coding units. The control storage unit includes a first control entry indicating first tile row information of a first tile row of a first tile of the multiple tiles. The first tile row information indicates a first slice identifier of a first slice that includes at least a portion of the first tile row of the first tile. The first memory is also configured to store first slice information that corresponds to the first slice identifier. The device also includes a processor configured to retrieve the first slice identifier from the first control entry stored in the first memory. The processor is also configured to obtain, based on the retrieved first slice identifier, the first slice information from the first memory. The processor is further configured to generate the first tile row of the first tile based at least in part on the first slice information.

According to another implementation of the present disclosure, a method includes receiving, at a device, a bitstream representing multiple tiles of an image frame. Each of the multiple tiles includes a plurality of tile rows of coding units. The method also includes processing, at an entropy decoder of the device, the bitstream to determine slice information of a slice that includes at least a portion of a tile row of a tile of the multiple tiles. The method also includes storing the slice information in a first memory of the device. The method also includes for the tile row, generating a control entry of a control storage unit included in the first memory of the device. The control entry indicates tile row information. The tile row information indicates a slice identifier of the slice.

According to another implementation of the present disclosure, a method includes retrieving, at a pixel processor of a device, a slice identifier from a control entry of a control storage unit included in a first memory. The control storage unit is associated with an image frame that includes multiple tiles. Each of the multiple tiles includes a plurality of tile rows of coding units. The control entry indicates tile row information of a tile row of a tile of the multiple tiles. The tile row information includes the slice identifier of a slice that includes at least a portion of the tile row. The method also includes obtaining, based on the retrieved slice identifier, slice information from the first memory. The method further includes generating, at the pixel processor of the device, the tile row based at least in part on the slice information.

According to another implementation of the present disclosure, a non-transitory computer-readable medium includes instructions that, when executed by a processor, cause the processor to receive a bitstream representing multiple tiles of an image frame. Each of the multiple tiles includes a plurality of tile rows of coding units. The instructions, when executed by the processor, also cause the processor to process, at an entropy decoder, the bitstream to determine slice information of a slice that includes at least a portion of a tile row of a tile of the multiple tiles. The instructions, when executed by the processor, further cause the processor to store the slice information in a first memory. The instructions, when executed by the processor, also cause the processor to, for the tile row, generate a control entry of a control storage unit included in the first memory. The control entry indicates tile row information. The tile row information indicates a slice identifier of the slice.

According to another implementation of the present disclosure, a non-transitory computer-readable medium includes instructions that, when executed by a processor, cause the processor to retrieve, at a pixel processor, a slice identifier from a control entry of a control storage unit included in a first memory. The control storage unit is associated with an image frame that includes multiple tiles. Each of the multiple tiles includes a plurality of tile rows of coding units. The control entry indicates tile row information of a tile row of a tile of the multiple tiles. The tile row information includes the slice identifier of a slice that includes at least a portion of the tile row. The instructions, when executed by the processor, also cause the processor to obtain, based on the retrieved slice identifier, slice information from the first memory. The instructions, when executed by the processor, also cause the processor to generate, at the pixel processor, the tile row based at least in part on the slice information.

According to one implementation of the present disclosure, an apparatus includes means for storing control entries associated with an image frame. The apparatus also includes means for receiving a bitstream representing multiple tiles of the image frame. Each of the multiple tiles includes a plurality of tile rows of coding units. The apparatus further includes means for generating a control entry of the means for storing control entries, the control entry generated for a tile row of a tile of the multiple tiles. The control entry includes tile row information that indicates a slice identifier of a slice that includes at least a portion of the tile row.

According to another implementation of the present disclosure, an apparatus includes means for storing control entries associated with an image frame that includes multiple tiles. Each of the multiple tiles includes a plurality of tile rows of coding units. The means for storing control entries includes a first control entry indicating first tile row information of a first tile row of a first tile of the multiple tiles. The first tile row information indicates a first slice identifier of a first slice that includes at least a portion of the first tile row of the first tile. The apparatus also includes means for storing first slice information that corresponds to the first slice identifier. The apparatus further includes means for retrieving the first slice identifier from the first control entry. The apparatus also includes means for obtaining, based on the retrieved first slice identifier, the first slice information from the means for storing the first slice information. The apparatus further includes means for generating the first tile row of the first tile based at least in part on the first slice information.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a block diagram of a particular illustrative aspect of a system operable to store slice information in an image data control storage unit, in accordance with some examples of the present disclosure.

FIG. 2 is a diagram of an illustrative aspect of a bitstream received at a device of the system of FIG. 1, in accordance with some examples of the present disclosure.

FIG. 3 is a diagram of an illustrative aspect of operations of an entropy decoder of the device of FIG. 1 associated with receiving slice header data of the bitstream of FIG. 1, in accordance with some examples of the present disclosure.

FIG. 4A is a diagram of an illustrative aspect of operations of the entropy decoder of the device of FIG. 1 associated with receiving a representation of a first slice of the bitstream of FIG. 1, in accordance with some examples of the present disclosure.

FIG. 4B is a diagram of an illustrative aspect of operations of the entropy decoder of the device of FIG. 1 associated with receiving representations of slices of the bitstream of FIG. 1, in accordance with some examples of the present disclosure.

FIG. 5A is a diagram of an illustrative aspect of operations of a pixel processor of the device of FIG. 1 associated with populating buffers of an on-chip memory for single pipeline processing, in accordance with some examples of the present disclosure.

FIG. 5B is a diagram of an illustrative aspect of operations of the pixel processor of the device of FIG. 1 associated with using a single processing pipeline to generate a portion of an image frame of the bitstream of FIG. 1, in accordance with some examples of the present disclosure.

FIG. 6A is a diagram of an illustrative aspect of operations of a pixel processor of the device of FIG. 1 associated with populating buffers of an on-chip memory for multiple pipeline processing, in accordance with some examples of the present disclosure.

FIG. 6B is a diagram of an illustrative aspect of operations of the pixel processor of the device of FIG. 1 associated with using multiple processing pipelines to generate a portion of an image frame of the bitstream of FIG. 1, in accordance with some examples of the present disclosure.

FIG. 7 is a diagram of an illustrative aspect of an example in which multiple slices include a respective portion of a tile row of an image frame of the system of FIG. 1, in accordance with some examples of the present disclosure.

FIG. 8 is a diagram of an illustrative aspect of a control entry format of a control entry of the system of FIG. 1, in accordance with some examples of the present disclosure.

FIG. 9 illustrates an example of an integrated circuit operable to store slice information in an image data control storage unit, in accordance with some examples of the present disclosure.

FIG. 10 is a diagram of a mobile device operable to store slice information in an image data control storage unit, in accordance with some examples of the present disclosure.

FIG. 11 is a diagram of a wearable electronic device operable to store slice information in an image data control storage unit, in accordance with some examples of the present disclosure.

FIG. 12 is a diagram of a mixed reality or augmented reality glasses device operable to store slice information in an image data control storage unit, in accordance with some examples of the present disclosure.

FIG. 13 is a diagram of a headset, such as a virtual reality, mixed reality, or augmented reality headset, operable to store slice information in an image data control storage unit, in accordance with some examples of the present disclosure.

FIG. 14 is a diagram of a first example of a vehicle operable to store slice information in an image data control storage unit, in accordance with some examples of the present disclosure.

FIG. 15 is a diagram of a second example of a vehicle operable to store slice information in an image data control storage unit, in accordance with some examples of the present disclosure.

FIG. 16 is a diagram of a particular implementation of a method of storing slice information in an image data control storage unit that may be performed by the device of FIG. 1, in accordance with some examples of the present disclosure.

FIG. 17 is a diagram of a particular implementation of a method of using stored slice information in an image data control storage unit that may be performed by the device of FIG. 1, in accordance with some examples of the present disclosure.

FIG. 18 is a block diagram of a particular illustrative example of a device that is operable to store slice information in an image data control storage unit, in accordance with some examples of the present disclosure.

### DETAILED DESCRIPTION

Computing devices often incorporate functionality to receive image data, such as an encoded video stream. Such devices may include a decoder that decodes an image frame of the video stream and outputs the image frame to a display device. Outputting decoded image portions, as compared to waiting for an entire image to be reconstructed prior to display, can reduce display latency and improve user experience.

Systems and methods of storing slice information in an image data control storage unit are disclosed. In some examples, an image frame is logically partitioned into tiles of coding units. Each tile includes one or more tile rows. An encoder (e.g., at a transmitting device) encodes slices of the image frame. In some examples, a slice includes one or more tile rows. The encoder generates a bitstream that includes slice header data followed by representations (e.g., encoded versions) of the slices. The slice header data includes slice information of the slices, and a representation of a slice includes representations of the tile rows in the slice. For example, a representation of a tile row includes tile row header information and tile row coefficient information. The encoder (e.g., the transmitting device) provides the bitstream to an image processing engine (e.g., at a receiving device).

The image processing engine includes an entropy decoder, an on-chip memory, and a pixel processor, and is coupled to an off-chip memory. The entropy decoder stores the slice header data and the representations of the slices in the off-chip memory. The off-chip memory also includes a control storage unit. In some examples, the control storage unit is a data structure that is stored at or included in the off-chip memory. Additionally, or alternatively, the control storage unit corresponds to or includes a table, an array, or other type of data structure generated by the entropy decoder. In some implementations, the control storage unit includes a register, a series of registers, a dedicated memory portion, one or more portions of the off-chip memory, or a combination thereof. The slice header data, the representations of the slices, and the control storage unit included in the off-chip memory are accessible or usable by the pixel processor to reconstruct the image frame.

The entropy decoder generates a control entry of the control storage unit that can be used to reconstruct a tile row of the image frame. The entropy decoder generates, for the tile row, the control entry to indicate a slice identifier of a slice that includes the tile row and location data of a representation of the tile row. The pixel processor prefetches the control entry from the off-chip memory to the on-chip memory, uses the slice identifier from the control entry to copy slice information of the slice to the on-chip memory, and uses the location data of the representation of the tile row to copy the representation of the tile row to the on-chip memory. The pixel processor processes the representation of the tile row using the slice information to generate (e.g., reconstruct) the tile row.

A technical advantage of using the slice identifier indicated in the control entry to retrieve the slice information includes a reduction in reconstruction latency of the tile row, as compared to using the location data indicated in the control entry to retrieve the tile row representation, parsing the tile row representation to determine the slice identifier, and then using the slice identifier to retrieve the slice information. Reduced reconstruction latency corresponds to reduced display latency of at least a portion of the image frame and improved user experience. There are similar advantages of having the slice identifier in the control entry in examples in which the slice includes a portion of a tile row.

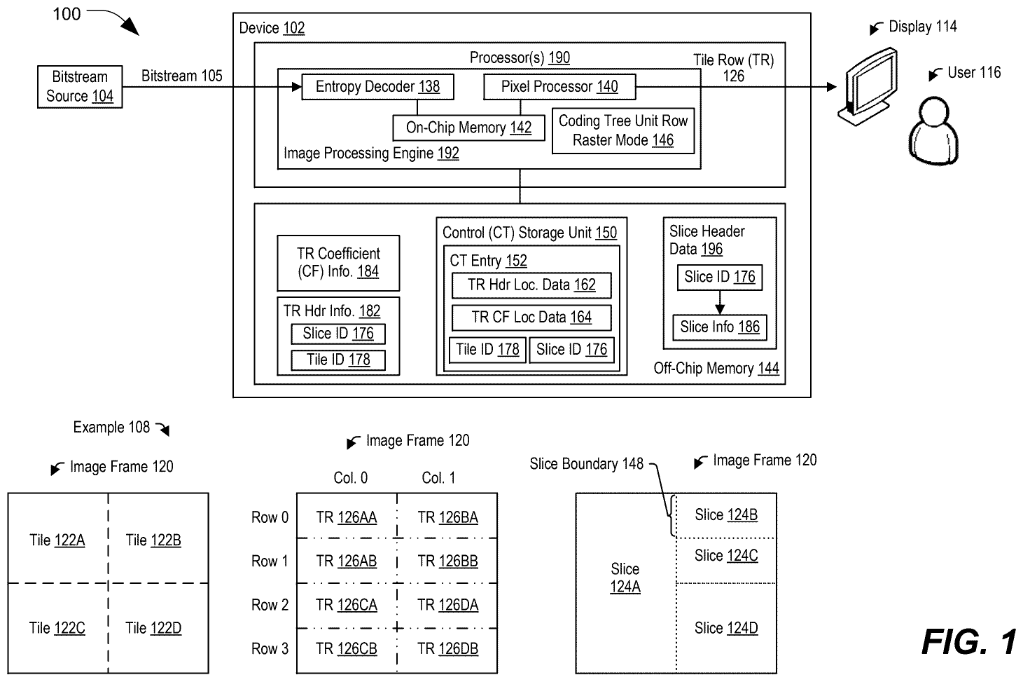

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor(s) 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein, e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple tiles are illustrated and associated with reference numbers 122A, 122B, 122C, and 122D. When referring to a particular one of these tiles, such as a tile 122A, the distinguishing letter “A” is used. However, when referring to any arbitrary one of these tiles or to these tiles as a group, the reference number 122 is used without a distinguishing letter.

As used herein, the terms “comprise,” “comprises,” and “comprising” may be used interchangeably with “include,” “includes,” or “including. ” Additionally, the term “wherein” may be used interchangeably with “where. ” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality”refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system configured to store slice information in an image data control storage unit is disclosed and generally designated 100. The system 100 includes a device 102 that is configured to be coupled to a bitstream source 104. In some aspects, the bitstream source 104 includes a network device, a storage device, a server, a mobile device, a camera, a vehicle, or a combination thereof. Optionally, in some embodiments, the device 102 may also be coupled to a display device 114. Although the bitstream source 104 and the display device 114 are illustrated as external to the device 102, in other embodiments the bitstream source 104, the display device 114, or both, may be integrated in the device 102.

The device 102 includes one or more processors 190 coupled to an off-chip memory 144. The processor(s) 190 include an image processing engine 192 that includes an entropy decoder 138 coupled via an on-chip memory 142 to a pixel processor 140. In a particular aspect, the image processing engine 192 corresponds to a system-on-chip that includes the entropy decoder 138, the on-chip memory 142, and the pixel processor 140. The image processing engine 192 is coupled to the off-chip memory 144.

An image frame 120 can be subdivided into a plurality of coding units, such as pixels, blocks, macroblocks, transform coefficients, coding tree units (CTUs), coding units (CUs), prediction units (PUs), transform units (TUs), or a combination thereof. In an example 108, an image frame 120 is logically divided into a plurality of tiles 122 of coding units, such as a tile 122A, a tile 122B, a tile 122C, a tile 122D, one or more additional tiles, or a combination thereof. Each tile 122 includes one or more tile rows 126 of coding units. For example, the tile 122A includes a tile row (TR) 126AA and a tile row 126AB. The tile 122B includes a tile row 126BA and a tile row 126BB. The tile 122C includes a tile row 126CA and a tile row 126CB. The tile 122D includes a tile row 126DA and a tile row 126 DB. Although the image frame 120 is described as including 4 tiles, in other examples the image frame 120 can include fewer than 4 or more than 4 tiles. A tile 122 including two tile rows 126 is provided as an illustrative example, in other examples a tile 122 can include fewer than two or more than two tile rows 126.

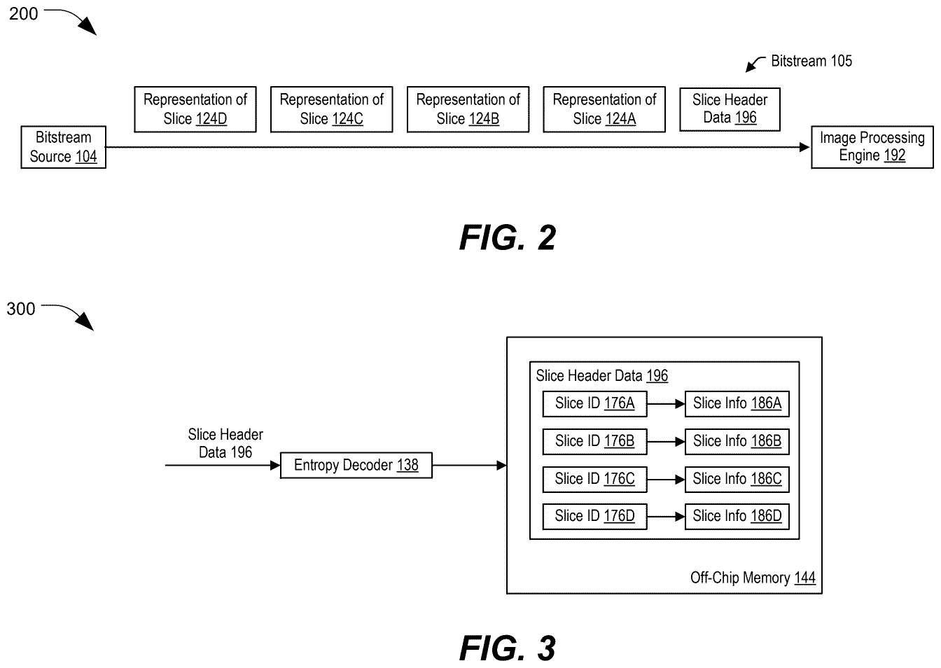

The entropy decoder 138 is configured to receive a bitstream 105 that includes a representation of the image frame 120 and header information, as further described with reference to FIG. 2. In an example, an encoder (e.g., at a transmitting device) encodes slices 124 of the image frame 120 to generate the representation of the image frame 120 and the header information. Optionally, in some embodiments, the encoder encodes the slices 124 in compliance with a video compression standard, such as a high efficiency video coding (HEVC) standard. The bitstream source 104 (e.g., the transmitting device) is configured to generate the bitstream 105 that includes slice header data 196 followed by representations (e.g., encoded versions) of the slices 124. The slice header data 196 includes slice information 186 of the slices 124. In some aspects, a slice 124 includes one or more tile rows 126 and a representation of the slice 124 includes representations of the one or more tile rows 126 in the slice 124. In some other aspects, a slice 124 includes a portion of a tile row 126 and a representation of the slice 124 includes a representation of the portion of the tile row 126 in the slice 124.

The off-chip memory 144 includes a control (CT) storage unit 150 (e.g., an image data control storage unit) associated with the image frame 120. The entropy decoder 138 is configured to obtain data (e.g., the slice header data 196 and the representation of the tile rows 126) from the bitstream 105 store the data in the off-chip memory 144. In some examples, the CT storage unit 150 corresponds to, includes, or is a data structure (e.g., a table, an array, or another data structure) that is generated by the entropy decoder 138 and stored in the off-chip memory 144. Additionally, or alternatively, the CT storage unit 150 may include or correspond to a register, a series of registers, a dedicated memory portion, or a combination thereof, associated with the image frame 120. The pixel processor 140 is configured to process the data using the control storage unit 150 to generate (e.g., reconstruct) the tile rows 126 of the image frame 120. Optionally, in some aspects, the pixel processor 140 is configured to provide a tile row 126 to the display device 114 prior to reconstructing one or more remaining tile rows 126 of the image frame 120.

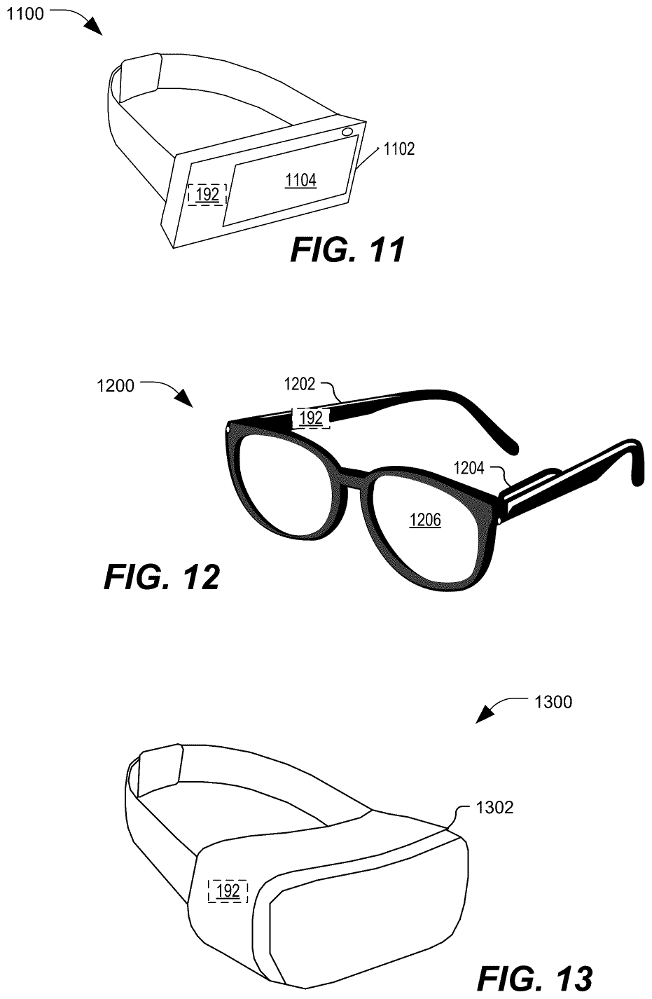

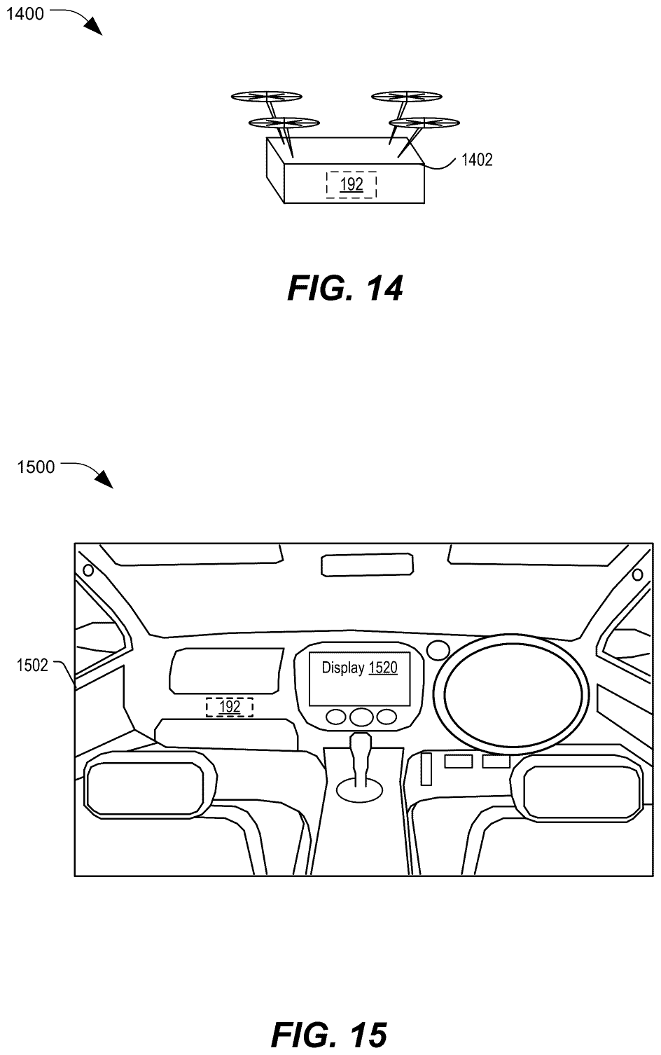

In some embodiments, the device 102 corresponds to or is included in one of various types of devices. In an illustrative example, the processor(s) 190 are integrated in at least one of a mobile phone or a tablet computer device, as described with reference to FIG. 10, a wearable electronic device, as described with reference to FIG. 11, mixed reality or augmented reality eye glasses, as described with reference to FIG. 12, or a virtual reality, mixed reality, or augmented reality headset, as described with reference to FIG. 13. In another illustrative example, the processor(s) 190 are integrated into a vehicle, such as described further with reference to FIG. 14 and FIG. 15.

During operation, an encoder device (e.g., the bitstream source 104 or another encoder device) generates a bitstream 105 representing multiple tiles 122 of an image frame 120. Each of the multiple tiles 122 includes a plurality of tile rows 126 of coding units. In a particular embodiment, the encoder device encodes slices 124 of the image frame 120 to generate the bitstream 105.

In the example 108, a slice 124A includes the tile 122A (e.g., the tile rows 126AA and 126AB), and the tile 122C (e.g., the tile rows 126CA and 126CB). A slice 124B includes the tile row 126BA of the tile 122B. A slice 124C includes the tile row 126BB of the tile 122B. A slice 124D includes the tile 122D (e.g., the tile rows 126DA and 126DB). The image frame 120 includes slice boundaries between slices. For example, the image frame 120 includes a slice boundary 148 between the tile row 126AA of the slice 124A and the tile row 126BA of the slice 124B.

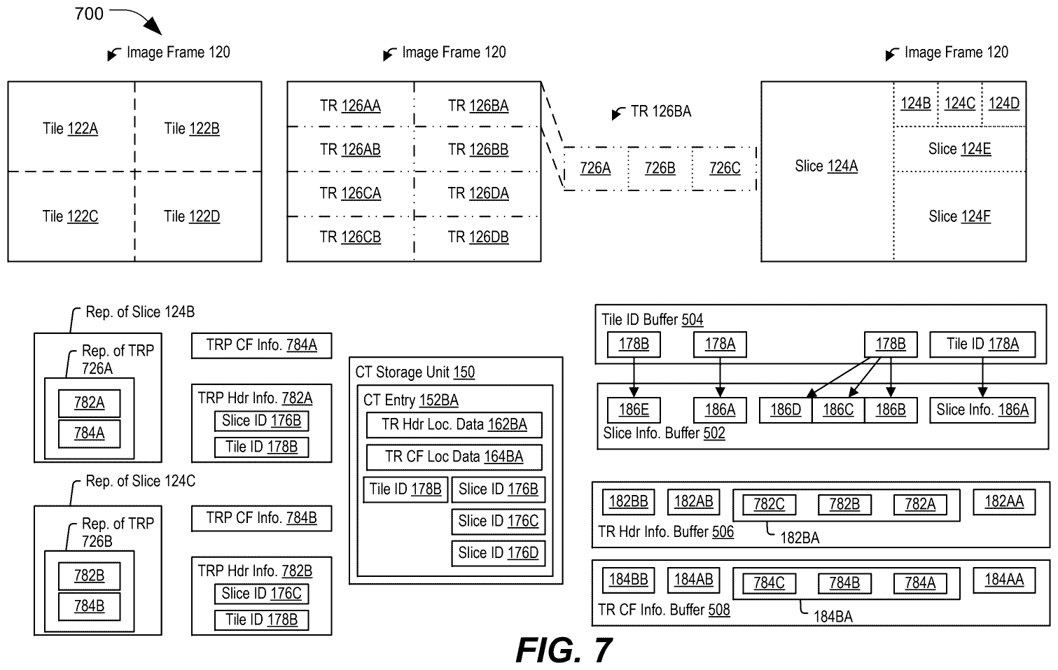

The bitstream 105 includes slice header data 196 followed by representations of the slices 124, as further described with reference to FIG. 2. The slice header data 196 indicates slice information 186 of the slices 124. In an example, the slice information 186 of a particular slice 124 is retrievable from the slice header data 196 using a slice identifier (ID) 176 of the slice 124. In a particular example, a representation of a slice 124 includes a representation of one or more tile rows 126 included in the slice 124. In another example, a representation of a slice 124 includes a representation of a tile row portion included in the slice 124, as further described with reference to FIG. 7. The bitstream source 104 provides the bitstream 105 to the image processing engine 192. In a particular embodiment, the device 102 stores one or more portions of the bitstream 105 in a buffer (e.g., a de-jitter buffer) and the image processing engine 192 retrieves one or more portions of the bitstream 105 from the buffer. To illustrate, the buffer may be included in the off-chip memory 144.

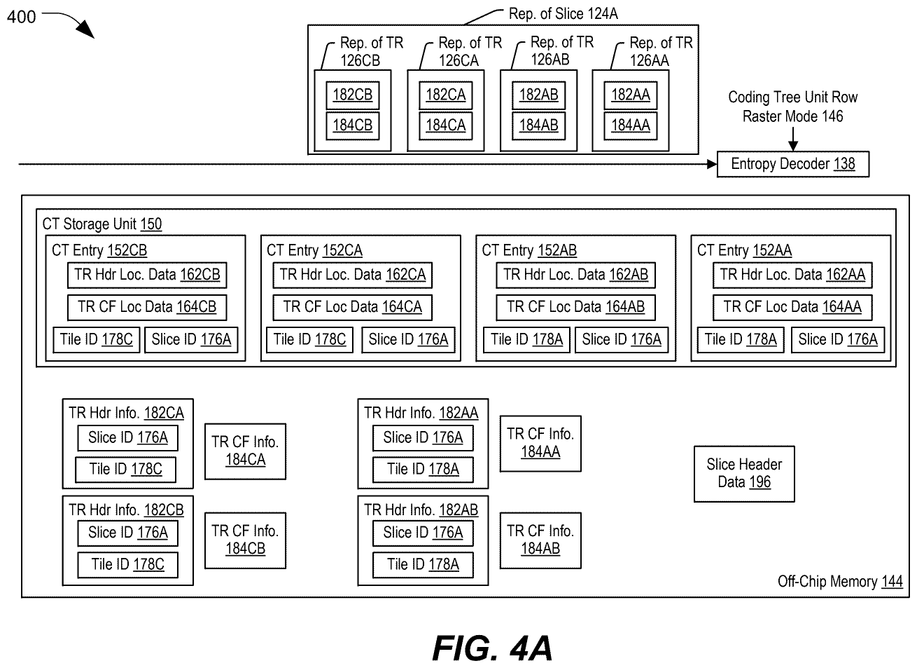

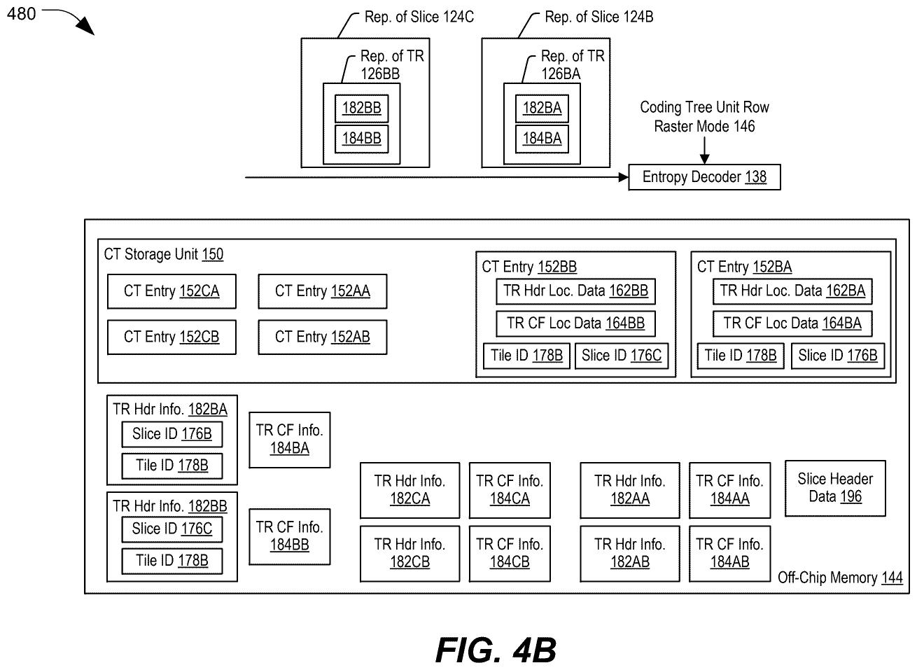

The image processing engine 192 processes the bitstream 105 to generate one or more of the tile rows 126, as further described with reference to FIGS. 3-7. For example, the entropy decoder 138 obtains the slice header data 196 from the bitstream 105 and stores the slice header data 196 in the off-chip memory 144, as further described with reference to FIG. 3. The entropy decoder 138 subsequently receives a representation of a slice 124 that includes representations of tile rows 126 of the slice 124, as further described with reference to FIGS. 4A and 4B. For example, the entropy decoder 138 receives a representation of a slice 124A that includes representations of tile rows 126 (e.g., the tile row 126AA, the tile row 126AB, the tile row 126CA, and the tile row 126CB) of the slice 124A.

A representation of a tile row 126 includes tile row header (Hdr) information (info.) 182 and tile row coefficient (CF) information 184. The tile row header information 182 indicates a slice identifier 176 of a slice 124 that includes at least a portion of the tile row 126 and a tile identifier 178 of a tile 122 that includes the tile row 126. The tile row coefficient information 184 represents image data of the tile row 126. In a particular aspect, a discrete cosine transform (DCT) operation is performed (e.g., at the encoder device) on at least a portion of the entire image frame 120 that includes the tile row 126 to generate coefficients, and the tile row coefficient information 184 is based on the coefficients. For example, the tile row coefficient information 184 includes at least some of the coefficients or quantized versions of the coefficients.

For each representation of a tile row 126 of a slice 124, the entropy decoder 138 stores the representation of the tile row 126 in the off-chip memory 144, as further described with reference to FIGS. 4A and 4B. For example, the entropy decoder 138 stores tile row header information 182 of a tile row 126 in a first location of the off-chip memory 144 and generates tile row header location data 162 indicating at least (e.g., a first memory address of) the first location. To illustrate, the tile row header location data 162 is usable to retrieve the tile row header information 182 from the off-chip memory 144. As another example, the entropy decoder 138 stores tile row coefficient information 184 of the tile row 126 in a second location of the off-chip memory 144 and generates tile row coefficient location data 164 indicating at least (e.g., a second memory address of) the second location. To illustrate, the tile row coefficient location data 164 is usable to retrieve the tile row coefficient information 184 from the off-chip memory 144.

For each representation of a tile row 126 of a slice 124, the entropy decoder 138 generates a control entry 152 indicating tile row information of the tile row 126, as further described with reference to FIGS. 4A and 4B. For example, the tile row information of the control entry 152 indicates the tile row header location data 162 and the tile row coefficient location data 164. Additionally, the tile row information of the control entry 152 indicates the slice identifier 176 and the tile identifier 178 also indicated in the tile row header information 182. In a particular aspect, a single slice 124 includes at least the tile row 126 and the tile row information of the control entry 152 indicates the slice identifier 176 of the single slice 124. In another aspect, each of multiple slices includes a corresponding portion of the tile row 126, as further described with reference to FIG. 7, and the tile row information of the control entry 152 indicates slice identifiers 176 of the multiple slices. The entropy decoder 138 adds the control entry 152 to the control storage unit 150 included in the off-chip memory 144.

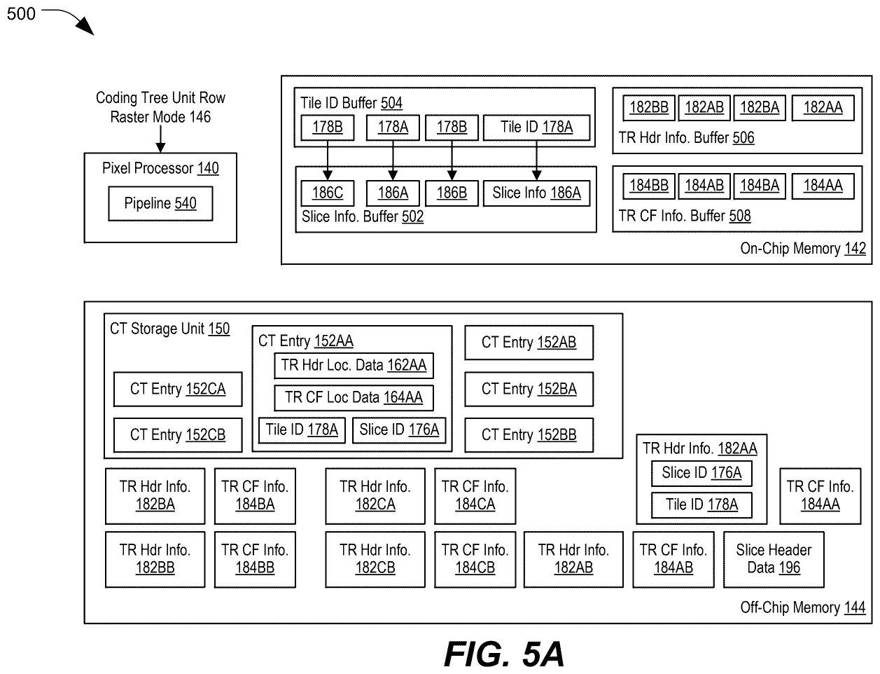

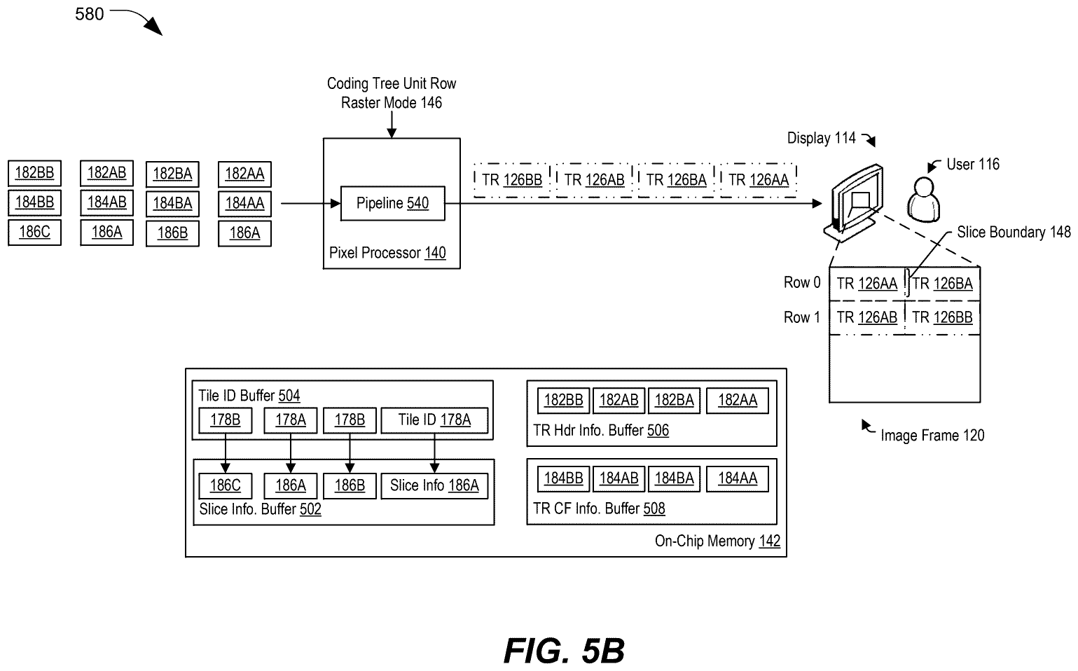

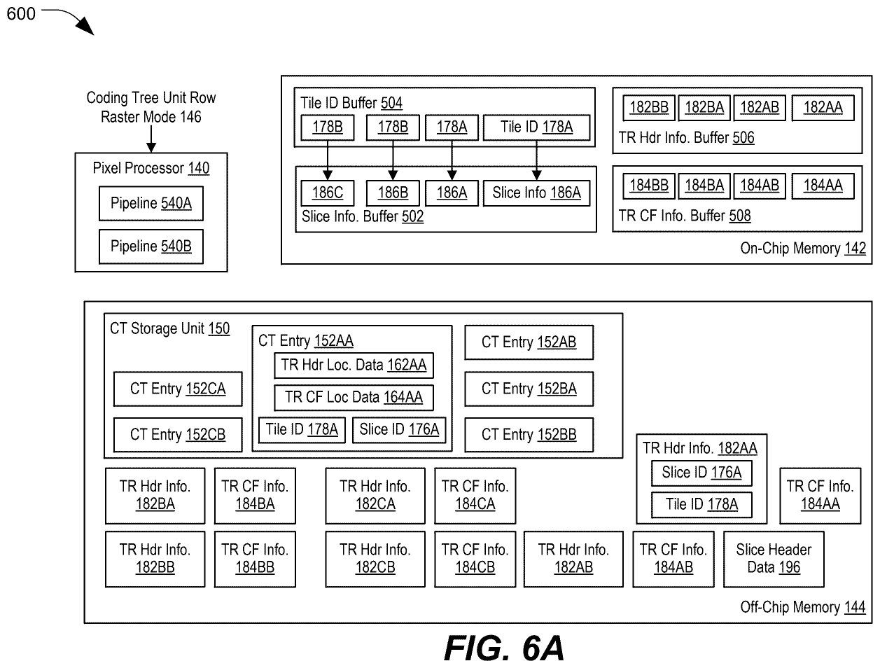

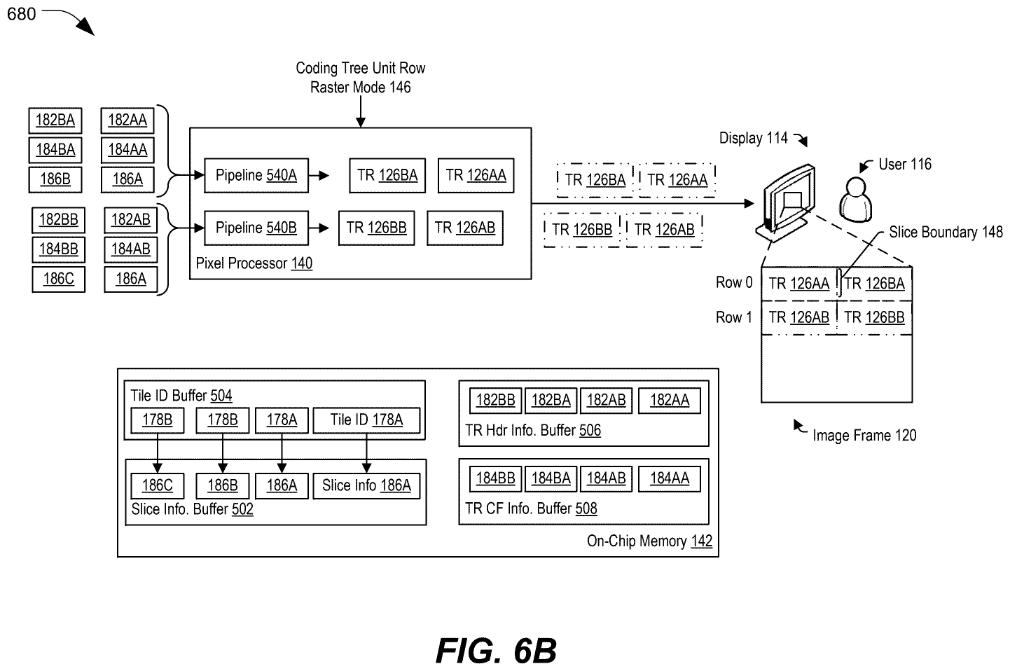

The pixel processor 140 fetches the control entry 152 from the off-chip memory 144, as further described with reference to FIGS. 5A and 6A. For example, the pixel processor 140, in response to determining that a tile 122 (e.g., a subsequent tile, such as a next tile) is to be processed, fetches (e.g., prefetches) one or more control entries 152 that indicate a tile identifier 178 of the tile 122 from the off-chip memory 144 to the on-chip memory 142.

The pixel processor 140 uses the information indicated in a control entry 152 stored in the on-chip memory 142 to generate a corresponding tile row 126, as further described with reference to FIGS. 5B and 6B. For example, the pixel processor 140 uses the tile row coefficient location data 164 indicated in the control entry 152 to retrieve the tile row coefficient information 184 from the off-chip memory 144 and uses the slice identifier 176 indicated in the control entry 152 to retrieve the slice information 186 from the slice header data 196 stored in the off-chip memory 144. The pixel processor 140 processes the tile row coefficient information 184 based on the slice information 186 to generate (e.g., reconstruct) the tile row 126. In some embodiments, the slice information 186 indicates slice header information (e.g., slice index, slice dimensions, tile position, etc.), coding parameters (e.g., compression method indicator, quantization parameters, entropy coding parameters, etc.), data offsets and sizes (e.g., start offset, slice data length, etc.), transformation and prediction parameters (e.g., coefficient information, prediction context, etc.), error resilience and correction parameters (e.g., error correction codes, resilience markers, etc.), or a combination thereof.

In some aspects, the pixel processor 140 uses the tile row header information 182 in addition to the slice information 186 to process the tile row coefficient information 184 to generate the tile row 126. For example, the tile row header information 182 can include tile row information. In some embodiments, the tile row information indicates tile row dimensions (e.g., a row index of the tile row 126, a count of columns included in the tile row 126, or both), a tile row position (e.g., the row index and a column index of the tile row 126), compression parameters (e.g., a compression method indicator, quantization parameters, coding tables, etc.), a color space indicator (e.g., RGB or YCbCr), bit depth, prediction parameters, error correction and validation parameters, or a combination thereof.

In a particular aspect, the image processing engine 192 performs progressive display, in which a tile row 126 is provided to the display device 114 as the tile row 126 is generated, without waiting for the entire image frame 120 to be reconstructed. Progressive display reduces a display latency associated with the image frame 120 and improves experience of a user 116, and can thereby increase viewer retention.

In some aspects, the reconstructed version of the tile row 126 can differ from an original version of the tile row 126 due to lossy compression, transmission errors, coding artifacts, etc. In some examples, any difference between the reconstructed version of the tile row 126 and the original version of the tile row 126 might not be noticeable to the user 116 when the reconstructed version of the tile row 126 is displayed.

Optionally, in some embodiments, the entropy decoder 138, selectively when a coding tree unit row raster mode 146 is activated, generates the control entry 152 to include a slice identifier 176. In some aspects, the coding tree unit row raster mode 146 is activated based on a user input, default data, a configuration setting, the bitstream 105, or a combination thereof. In an example, the pixel processor 140 is configured to, responsive to a determination that the coding tree unit row raster mode 146 is activated, generate the tile rows 126 based on a corresponding order (e.g., from left-to-right and top-to-bottom) of the image frame 120. To illustrate, the tile row 126AA corresponds to a first tile row position (e.g., row 0, column 0) in the image frame 120, the tile row 126BA corresponds to a second tile row position (e.g., row 0, column 1) in the image frame 120, the tile row 126AB corresponds to a third tile row position (e.g., row 1, column 0) in the image frame 120, the tile row 126BB corresponds to a fourth tile row position (e.g., row 1, column 1) in the image frame 120, and so on. The pixel processor 140, in response to determining that the coding tree unit row raster mode 146 is activated, generates the tile rows 126 in order of columns from left-to-right and rows from top-to-bottom. For example, the pixel processor 140 generates (e.g., reproduces) the tile row 126AA followed by the tile row 126BA of row 0, generates the tile row 126AB followed by the tile row 126BB of row 1, and so on. It should be understood that a “left-to-right and top-to-bottom” order based on the coding tree unit row raster mode 146 is provided as an illustrative example, in other examples the entropy decoder 138 can implement another order of processing and generating the tile rows 126 based on a detected condition. To illustrate, the detected condition can be based on activation of the coding tree unit row raster mode 146, a user input, a configuration setting, default data, or a combination thereof, indicating that a particular order is to be used to process and generate the tile row 126.

Having the slice identifier 176 in the control entry 152 that is copied to the on-chip memory 142 can improve performance when the pixel processor 140 crosses a slice boundary, such as the slice boundary 148 between the tile row 126AA and the tile row 126BA, by enabling slice information 186 of the slice 124B to be prefetched, as further described with reference to FIGS. 5A-6B. The prefetched slice information 186 reduces delay associated with using the slice information 186 at the slice boundary 148 between the tile row 126AA of the tile 122A and the tile row 126BA of the tile 122B.

A technical advantage of the system 100 includes reduced display latency associated with displaying at least a portion of a reconstructed version of the image frame 120. Storing the slice identifier 176 in the control storage unit 150 enables retrieval of the slice information 186 independently of retrieval of the tile row header information 182 from the off-chip memory 144. For example, the pixel processor 140 can use the slice identifier 176 indicated in the control entry 152 (previously copied to the on-chip memory 142) to retrieve the slice information 186 from the off-chip memory 144, without having to first use the tile row header location data 162 to retrieve the tile row header information 182 from the off-chip memory 144, storing the tile row header information 182 in the on-chip memory 142, and then using the slice identifier 176 indicated in the tile row header information 182 to retrieve the slice information 186 from the off-chip memory 144. Storing the slice identifier 176 in the control storage unit 150 thus reduces the reconstruction and display latency of the tile row 126.

Referring to FIG. 2, a diagram 200 is shown of an illustrative aspect of a bitstream 105 received at the device 102 of the system 100 of FIG. 1, in accordance with some examples of the present disclosure. In a particular example, the bitstream source 104 of FIG. 1 outputs the bitstream 105 as shown in FIG. 2 and the bitstream 105 is received at the image processing engine 192 of the device 102.

The bitstream 105 is associated with the image frame 120 of FIG. 1 and includes the slice header data 196 and representations of the slices 124 of the image frame 120. In an example, the slice header data 196 is followed by a representation of the slice 124A, a representation of the slice 124B, a representation of the slice 124C, and a representation of the slice 124D. It should be understood that one or more portions of the bitstream 105 sent by the bitstream source 104 may be received out-of-order, received late, or not received at the device 102 because of network errors or delays. Optionally, in some aspects, the device 102 stores one or more portions of the bitstream 105 in a buffer (e.g., a de-jitter buffer) and the entropy decoder 138 retrieves portions of the bitstream 105 from the buffer.

Referring to FIG. 3, a diagram 300 is shown of an illustrative aspect of operations of the entropy decoder 138 of the device 102 of FIG. 1 associated with receiving the slice header data 196 of the bitstream 105 of FIG. 1, in accordance with some examples of the present disclosure.

The entropy decoder 138 stores the slice header data 196 in the off-chip memory 144. In an example, the slice header data 196 includes slice information 186 of the one or more slices 124 of the image frame 120. To illustrate, the slice header data 196 indicates that a slice identifier 176A of the slice 124A maps to the slice information 186A of the slice 124A, a slice identifier 176B of the slice 124B maps to the slice information 186B of the slice 124B, a slice identifier 176C of the slice 124C maps to the slice information 186C of the slice 124C, a slice identifier 176D of the slice 124D maps to the slice information 186D of the slice 124D, or a combination thereof.

Referring to FIG. 4A, a diagram 400 is shown of an illustrative aspect of operations of the entropy decoder 138 of the device 102 of FIG. 1 associated with receiving a representation of the slice 124A of the bitstream 105 of FIG. 1, in accordance with some examples of the present disclosure.

The representation of the slice 124A includes representations of the tile rows 126 of the slice 124A. For example, the representation of the slice 124A includes a representation of the tile row 126AA, a representation of the tile row 126AB, a representation of the tile row 126CA, and a representation of the tile row 126CB. Optionally, in some embodiments, the bitstream 105 includes representations of tile rows 126 of the slice 124A that are transmitted separately. For example, the representation of the tile row 126AA, the tile row 126AB, the tile row 126CA, and the tile row 126CB are received at a first time, a second time, a third time, and a fourth time, respectively, at the device 102. In some aspects, the representations of the tile rows 126 of the slice 124A are received in-order (e.g., top-to-bottom) at the device 102. For example, the first time is earlier than or equal to the second time, the second time is earlier than or equal to the third time, and the third time is earlier than or equal to the fourth time. In some aspects, one or more representations of the tile rows 126 of the slice 124A are received out-of-order at the device 102. For example, the second time can be earlier than the first time.

A representation of a tile row 126 includes tile row header information 182. For example, the representations of the tile row 126AA, the tile row 126AB, the tile row 126CA, and the tile row 126CB include the tile row header information 182AA, the tile row header information 182AB, the tile row header information 182CA, and the tile row header information 182CB, respectively.

The tile row header information 182 indicates slice and tile information of the tile row 126. For example, each of the tile row header information 182AA, the tile row header information 182AB, the tile row header information 182CA, and the tile row header information 182CB indicates the slice identifier 176A of the slice 124A. Each of the tile row header information 182AA and the tile row header information 182AB indicates a tile identifier 178A of the tile 122A. Each of the tile row header information 182CA and the tile row header information 182CB indicates a tile identifier 178C of the tile 122C.

In addition, a representation of a tile row 126 includes tile row coefficient information 184 of the tile row 126. For example, the representations of the tile row 126AA, the tile row 126AB, the tile row 126CA, and the tile row 126CB include tile row coefficient information 184AA of the tile row 126AA, tile row coefficient information 184AB of the tile row 126AB, tile row coefficient information 184CA of the tile row 126CA, and tile row coefficient information 184CB of the tile row 126CB, respectively.

The entropy decoder 138, in response to receiving the representation of the slice 124A of the bitstream 105, stores the representations of the tile rows 126 of the slice 124A in the off-chip memory 144. For example, the entropy decoder 138 stores the tile row header information 182AA, the tile row coefficient information 184AA, the tile row header information 182AB, the tile row coefficient information 184AB, the tile row header information 182CA, the tile row coefficient information 184CA, the tile row header information 182CB, and the tile row coefficient information 184CB in the off-chip memory 144.

The entropy decoder 138, for each of the tile rows 126 of the slice 124A, generates a control entry 152 of the control storage unit 150 included in the off-chip memory 144. For example, the entropy decoder 138 generates a control entry 152AA, a control entry 152AB, a control entry 152CA, and a control entry 152CB for the tile row 126AA, the tile row 126AB, the tile row 126CA, and the tile row 126CB, respectively.

A control entry 152 of a tile row 126 includes tile row header location data 162 and tile row coefficient location data 164 to enable retrieval of tile row header information 182 and tile row coefficient information 184, respectively, from the off-chip memory 144. For example, the tile row header location data 162 of the tile row header information 182 indicates a location (e.g., a memory address) of the off-chip memory 144 at which the tile row header information 182 is stored, and the tile row coefficient location data 164 of the tile row coefficient information 184 indicates a location (e.g., a memory address) of the off-chip memory 144 at which the tile row coefficient information 184 is stored.

As an example, the control entry 152AA includes tile row header location data 162AA of the tile row header information 182AA and tile row coefficient location data 164AA of the tile row coefficient information 184AA. Similarly, the control entry 152AB includes tile row header location data 162AB of the tile row header information 182AB, and tile row coefficient location data 164AB of the tile row coefficient information 184AB. As another example, the control entry 152CA includes tile row header location data 162CA of the tile row header information 182CA and tile row coefficient location data 164CA of the tile row coefficient information 184CA. Similarly, the control entry 152CB includes tile row header location data 162CB of the tile row header information 182CB and tile row coefficient location data 164CB of the tile row coefficient information 184CB.

In a particular aspect, the control entry 152 of the tile row 126 also indicates the tile 122 that includes the tile row 126. For example, each of the control entry 152AA and the control entry 152AB indicates the tile identifier 178A of the tile 122A and each of the control entry 152CA and the control entry 152CB includes the tile identifier 178C of the tile 122C.

The control entry 152 of a tile row 126 of the slice 124A indicates the slice identifier 176A of the slice 124A. For example, each of the control entry 152AA, the control entry 152AB, the control entry 152CA, and the control entry 152CB includes the slice identifier 176A of the slice 124A. Optionally, in some embodiments, the entropy decoder 138 generates the control entry 152 to selectively include a slice identifier 176 based on determining that the coding tree unit row raster mode 146 is activated. For example, when the coding tree unit row raster mode 146 is activated, the pixel processor 140 processes the representations of the tile rows 126 from left-to-right and top-to-bottom of the image frame 120. Having the slice identifier 176 in the control entry 152 enables prefetching of slice information 186 such that a latency associated with transitioning between processing a tile row 126 of one slice to processing a tile row 126 of another slice is reduced, as further described with reference to FIGS. 5B and 6B.

Referring to FIG. 4B, a diagram 480 is shown of an illustrative aspect of operations of the entropy decoder 138 of the device 102 of FIG. 1 associated with receiving a representation of the slice 124B and a representation of the slice 124C of the bitstream 105 of FIG. 1, in accordance with some examples of the present disclosure.

The representation of the slice 124B includes a representation of the tile row 126BA, and the representation of the slice 124C includes a representation of the tile row 126BB. The representation of the tile row 126BA includes the tile row header information 182BA and tile row coefficient information 184BA. The representation of the tile row 126BB includes the tile row header information 182BB and tile row coefficient information 184BB.

The tile row header information 182BA indicates the slice identifier 176B of the slice 124B. The tile row header information 182BB indicates the slice identifier 176C of the slice 124C. Each of the tile row header information 182BA and the tile row header information 182BB indicates a tile identifier 178B of the tile 122B.

The entropy decoder 138, in response to receiving the representation of the slice 124B of the bitstream 105, stores the representation of the tile row 126BA of the slice 124B in the off-chip memory 144. The entropy decoder 138, for the tile row 126BA of the slice 124B, generates a control entry 152BA of the control storage unit 150 included in the off-chip memory 144. The control entry 152BA includes tile row header location data 162BA of the tile row header information 182BA and tile row coefficient location data 164BA of the tile row coefficient information 184BA.

Similarly, the entropy decoder 138, in response to receiving the representation of the slice 124C of the bitstream 105, stores the representation of the tile row 126BB of the slice 124C in the off-chip memory 144. The entropy decoder 138, for the tile row 126BB of the slice 124C, generates a control entry 152BB of the control storage unit 150 included in the off-chip memory 144. For example, the control entry 152BB includes tile row header location data 162BB of the tile row header information 182BB and tile row coefficient location data 164BB of the tile row coefficient information 184BB.

Each of the control entry 152BA and the control entry 152BB indicates the tile identifier 178B of the tile 122B. The control entry 152BA includes the slice identifier 176B of the slice 124B. The control entry 152BB includes the slice identifier 176C of the slice 124C. Optionally, in some embodiments, the entropy decoder 138, in response to determining that the coding tree unit row raster mode 146 is activated, generates the control entry 152BA to indicate the slice identifier 176B and generates the control entry 152BB to indicate the slice identifier 176C.

Although a slice 124 including a multiple tile rows 126 is shown in the example of FIG. 4A and a slice 124 including a single tile row 126 is shown in the example of FIG. 4B, in some other examples a slice 124 can include a portion of a tile row 126, as further described with reference to FIG. 7.

Referring to FIG. 5A, a diagram 500 is shown of an illustrative aspect of operations of the pixel processor 140 of the device 102 of FIG. 1 associated with populating buffers of the on-chip memory 142 for single pipeline processing, in accordance with some examples of the present disclosure.

The pixel processor 140 populates a slice information buffer 502, a tile identifier buffer 504, a tile row header information buffer 506, and a tile row coefficient information buffer 508 in the on-chip memory 142 based on a selected order in which representations of tile rows 126 are to be processed. In a particular embodiment, when the coding tree unit row raster mode 146 is activated and the representations of the tile rows 126 are to be processed using a single processing pipeline 540, the representations of the tile rows 126 are to be processed in a first selected order (e.g., left-to-right and top-to-bottom).

In a particular aspect, a control entry 152 of a tile row 126 includes position data indicating a position of the tile row 126 in the image frame 120, as described with reference to FIG. 1. The pixel processor 140, based on tile row position data indicated by the control entries 152, identifies one or more control entries 152 that are to be processed next in accordance with the selected order and fetches one or more of the identified control entries 152. For example, the pixel processor 140 fetches the control entry 152AA (e.g., corresponding to Row 0, Column 0), the control entry 152BA (e.g., corresponding to Row 0, Column 1), the control entry 152AB (e.g., corresponding to Row 1, Column 0), the control entry 152BB (e.g., corresponding to Row 1, Column 1), or a combination thereof.

In a particular aspect, each of the slice information buffer 502, the tile identifier buffer 504, the tile row header information buffer 506, and the tile row coefficient information buffer 508 includes at least a first count of buffer slots, and the pixel processor 140 fetches (e.g., prefetches) the first count (e.g., up to a pre-determined number) of control entries 152 that are to be processed next from the control storage unit 150 included in the off-chip memory 144.

The pixel processor 140, in response to retrieving a control entry 152 from the off-chip memory 144, uses the control entry 152 retrieved from the off-chip memory 144 to update the slice information buffer 502, the tile identifier buffer 504, the tile row header information buffer 506, and the tile row coefficient information buffer 508. For example, the pixel processor 140, in response to retrieving the control entry 152AA from the off-chip memory 144, copies the tile identifier 178A indicated in the control entry 152AA retrieved from the off-chip memory 144 to a first slot of the tile identifier buffer 504. The pixel processor 140 uses the slice identifier 176A indicated in the control entry 152AA to retrieve the slice information 186A from the off-chip memory 144 and copies the slice information 186A to a first slot of the slice information buffer 502. The pixel processor 140 uses the tile row header location data 162AA indicated in the control entry 152AA to retrieve the tile row header information 182AA from the off-chip memory 144 and stores the tile row header information 182AA in a first slot of the tile row header information buffer 506. The pixel processor 140 uses the tile row coefficient location data 164AA indicated in the control entry 152AA to retrieve the tile row coefficient information 184AA from the off-chip memory 144 and stores the tile row coefficient information 184AA in a first slot of the tile row coefficient information buffer 508.

In a particular embodiment, the pixel processor 140 updates the first slot of the tile identifier buffer 504 to indicate an association with the first slot of the slice information buffer 502, the first slot of the tile row header information buffer 506, the first slot of the tile row coefficient information buffer 508, or a combination thereof. For example, the first slot of the tile identifier buffer 504 indicates the first slot of the slice information buffer 502. In another embodiment, a particular slot (e.g., the first slot) of the tile identifier buffer 504 having a particular slot index (e.g., slot index 0) is associated with a particular slot (e.g., the first slot) of the slice information buffer 502 having a corresponding slot index (e.g., the same slot index). In a particular embodiment, the first slot of the tile identifier buffer 504 is associated with the first slot (e.g., at slot index 0) of the tile row header information buffer 506 and the first slot (e.g., at slot index 0) of the tile row coefficient information buffer 508.

Similarly, the pixel processor 140, in response to retrieving the control entry 152BA from the off-chip memory 144, uses the control entry 152BA retrieved from the off-chip memory 144 to update the slice information buffer 502, the tile identifier buffer 504, the tile row header information buffer 506, and the tile row coefficient information buffer 508. For example, the pixel processor 140, in response to retrieving the control entry 152BA from the off-chip memory 144, copies the tile identifier 178B indicated in the control entry 152BA retrieved from the off-chip memory 144 to a second slot of the tile identifier buffer 504. The pixel processor 140 uses the slice identifier 176B indicated in the control entry 152BA to copy the slice information 186B from the off-chip memory 144 to a second slot of the slice information buffer 502. The pixel processor 140 uses the tile row header location data 162BA indicated in the control entry 152BA to copy the tile row header information 182BA from the off-chip memory 144 to a second slot of the tile row header information buffer 506. The pixel processor 140 uses the tile row coefficient location data 164BA indicated in the control entry 152BA to copy the tile row coefficient information 184BA from the off-chip memory 144 to a second slot of the tile row coefficient information buffer 508. The pixel processor 140 similarly updates the slice information buffer 502, the tile identifier buffer 504, the tile row header information buffer 506, and the tile row coefficient information buffer 508 in response to retrieving one or more additional control entries 152 from the off-chip memory 144.

A technical advantage of having the slice identifier 176 indicated in the control entry 152 for a tile row 126 includes enabling the pixel processor 140 to retrieve the slice information 186 from the off-chip memory 144 prior to or concurrently with retrieving the tile row header information 182 of the tile row 126 from the off-chip memory 144. When the slice identifier 176 in the control entry 152 is used to retrieve the slice information 186 from the off-chip memory 144, a latency of obtaining the slice information 186 is reduced as compared to using the tile row header location data 162 in the control entry 152 to retrieve the tile row header information 182 from the off-chip memory 144, parsing the tile row header information 182 to determine the slice identifier 176, and then using the slice identifier 176 to retrieve the slice information 186 from the off-chip memory 144.

Referring to FIG. 5B, a diagram 580 is shown of an illustrative aspect of operations of the pixel processor 140 of the device 102 of FIG. 1 associated with using a single processing pipeline 540 to generate a portion of an image frame 120 of the bitstream 105 of FIG. 1, in accordance with some examples of the present disclosure.

The pixel processor 140 processes data in the slice information buffer 502, the tile identifier buffer 504, the tile row header information buffer 506, and the tile row coefficient information buffer 508 to generate a first count of tile rows 126 of the image frame 120. For example, the pixel processor 140 retrieves the tile row header information 182AA, the tile row coefficient information 184AA, and the slice information 186A from the tile row header information buffer 506, the tile row coefficient information buffer 508, and the slice information buffer 502, respectively. The pixel processor 140 uses the pipeline 540 to process the tile row header information 182AA, the tile row coefficient information 184AA, and the slice information 186A to generate (e.g., reproduce) the tile row 126AA. In a particular aspect, the pixel processor 140 provides the tile row 126AA to the display device 114. For example, the pixel processor 140 uses the pipeline 540 to process the tile row header information 182AA, the tile row coefficient information 184AA, and the slice information 186A to generate (e.g., reproduce) pixel values corresponding to the tile row 126AA and provides the pixel values and position data of the tile row 126AA to the display device 114.

The pixel processor 140 can thus process the slice information 186A that has been fetched and stored in the slice information buffer 502, without the latency associated with parsing the tile row header information 182AA retrieved from the tile row header information buffer 506 to determine the slice identifier 176A and then using the slice identifier 176A to retrieve the slice information 186A from the off-chip memory 144. A reduction in the reproduction latency of the tile row 126AA results in a reduction in display latency of the tile row 126AA. In a particular aspect, prefetching the slice information 186A corresponds to fetching the slice information 186A from the off-chip memory 144 prior to parsing the tile row header information 182AA to determine the slice identifier 176A.

The pixel processor 140 continues processing data of the slice information buffer 502, the tile row header information buffer 506, and the tile row coefficient information buffer 508 to generate tile rows 126. For example, the pixel processor 140 retrieves the tile row header information 182BA, the tile row coefficient information 184BA, and the slice information 186B from the tile row header information buffer 506, the tile row coefficient information buffer 508, and the slice information buffer 502, respectively. The pixel processor 140 use the pipeline 540 to process the tile row header information 182BA, the tile row coefficient information 184BA, and the slice information 186B to generate (e.g., reproduce) the tile row 126BA. In a particular aspect, the pixel processor 140 provides the tile row 126BA to the display device 114.

The pixel processor 140 can thus process the slice information 186B that has been fetched and stored in the slice information buffer 502, without the latency associated with parsing the tile row header information 182BA retrieved from the tile row header information buffer 506 to detect crossing the slice boundary 148 to the slice 124B corresponding to the slice identifier 176B and then using the slice identifier 176B to retrieve the slice information 186B from the off-chip memory 144. The buffered slice information 186B reduces delay associated with using the slice information 186B at the slice boundary 148 between the tile row 126AA of the tile 122A and the tile row 126BA of the tile 122B. Similarly, the pixel processor 140 uses data retrieved from the tile row header information buffer 506, the tile row coefficient information buffer 508, and the slice information buffer 502 to generate (e.g., reproduce) one or more additional tile rows 126 (e.g., the tile row 126AB and the tile row 126BB).

Optionally, in some embodiments, the pixel processor 140 performs progressive display in which the tile row 126AA and the tile row 126BA are provided to the display device 114 prior to generating remaining tile rows of the image frame 120. A technical advantage of the progressive display includes reduced display latency associated with displaying at least a portion of the image frame 120 to the user 116. Having the slice information 186 in the slice information buffer 502 further reduces display latency associated with displaying at least a portion of the image frame 120 to the user 116.

Referring to FIG. 6A, a diagram 600 is shown of an illustrative aspect of operations of the pixel processor 140 of the device 102 of FIG. 1 associated with populating buffers of the on-chip memory 142 for multiple pipeline processing, in accordance with some examples of the present disclosure.

In a particular embodiment, when the coding tree unit row raster mode 146 is activated and the representations of the tile rows are to be processed using multiple processing pipelines 540 (e.g., a pipeline 540A and a pipeline 540B), the representations of the tile rows are to be processed in a selected order (e.g., left-to-right and top-to-bottom order) of a count of tile rows corresponding to a count of processing pipelines 540. For example, the pixel processor 140, in response to determining that the coding tree unit row raster mode 146 is activated and that two processing pipelines (e.g., the pipeline 540A and the pipeline 540B) are to be used, determines that the representations of the tile rows are to be processed left-to-right and top-to-bottom of two Rows of the image frame 120, as described herein.

The pixel processor 140, based on tile row position data indicated by the control entries 152, identifies one or more control entries 152 that are to be processed subsequently (e.g., next) in accordance with the selected order and fetches (e.g., prefetches) one or more of the identified control entries 152. For example, the pixel processor 140 fetches the control entry 152AA and the control entry 152AB corresponding to a first column (e.g., Column 0) of two rows (e.g., Rows 0 and 1) of the image frame 120 followed by the control entry 152BA and the control entry 152BB corresponding to the next right column (e.g., Column 1) of the two rows (e.g., Rows 0 and 1) of the image frame 120.

The pixel processor 140, in response to retrieving a control entry 152 from the off-chip memory 144, uses the control entry 152 retrieved from the off-chip memory 144 to update the slice information buffer 502, the tile identifier buffer 504, the tile row header information buffer 506, and the tile row coefficient information buffer 508, as described with reference to FIG. 5A. For example, the pixel processor 140, in response to retrieving the control entry 152AA from the off-chip memory 144, copies the tile identifier 178A to a first slot of the tile identifier buffer 504, uses the slice identifier 176A to copy the slice information 186A from the off-chip memory 144 to a first slot of the slice information buffer 502, uses the tile row header location data 162AA to copy the tile row header information 182AA from the off-chip memory 144 to a first slot of the tile row header information buffer 506, and uses the tile row coefficient location data 164AA to copy the tile row coefficient information 184AA from the off-chip memory 144 to a first slot of the tile row coefficient information buffer 508, as described with reference to FIG. 5A.

Similarly, in another example, the pixel processor 140, in response to retrieving the control entry 152AB from the off-chip memory 144, copies the tile identifier 178A to a second slot of the tile identifier buffer 504, copies the slice information 186A from the off-chip memory 144 to a second slot of the slice information buffer 502, copies the tile row header information 182AB from the off-chip memory 144 to a second slot of the tile row header information buffer 506, and copies the tile row coefficient information 184AB from the off-chip memory 144 to a second slot of the tile row coefficient information buffer 508. The pixel processor 140 similarly updates the slice information buffer 502, the tile identifier buffer 504, the tile row header information buffer 506, and the tile row coefficient information buffer 508 in response to retrieving one or more additional control entries 152 from the off-chip memory 144.

Referring to FIG. 6B, a diagram 680 is shown of an illustrative aspect of operations of the pixel processor 140 of the device 102 of FIG. 1 associated with using multiple processing pipelines to generate a portion of an image frame 120 of the bitstream 105 of FIG. 1, in accordance with some examples of the present disclosure.

Optionally, in some embodiments, the pixel processor 140 concurrently processes the data using multiple processing pipelines 540, such as a pipeline 540A, a pipeline 540B, one or more additional processing pipelines, or a combination thereof, to concurrently generate tile rows 126 of multiple rows of the image frame 120. To illustrate, the pixel processor 140, concurrently with using the pipeline 540A to generate the tile row 126AA and the tile row 126BA of a first row (e.g., Row 0) of the image frame 120, uses the pipeline 540B to generate the tile row 126AB and the tile row 126BB of a second row (e.g., Row 1) of the image frame 120, as described herein.

The pixel processor 140 processes data in the slice information buffer 502, the tile identifier buffer 504, the tile row header information buffer 506, and the tile row coefficient information buffer 508 to generate one or more tile rows 126 of the image frame 120. In an example, the pixel processor 140 retrieves the tile row header information 182AA, the tile row coefficient information 184AA, and the slice information 186A from the tile row header information buffer 506, the tile row coefficient information buffer 508, and the slice information buffer 502, respectively.

In a particular embodiment, the pixel processor 140, in response to determining that the tile row header information 182AA indicates that the tile row header information 182AA is associated with a first row (e.g., Row 0) of the image frame 120, designates the pipeline 540A for generating (e.g., reproducing) tile rows 126 of the first row. The pixel processor 140 uses the pipeline 540A to process the tile row header information 182AA, the tile row coefficient information 184AA, and the slice information 186A to generate (e.g., reproduce) the tile row 126AA. In a particular aspect, the pixel processor 140 provides the tile row 126AA to the display device 114, as described with reference to FIG. 5B.

The pixel processor 140 retrieves the tile row header information 182AB, the tile row coefficient information 184AB, and the slice information 186A from the tile row header information buffer 506, the tile row coefficient information buffer 508, and the slice information buffer 502, respectively. In a particular embodiment, the pixel processor 140, in response to determining that the tile row header information 182AB indicates that the tile row header information 182AB is associated with a second row (e.g., Row 1) of the image frame 120 and determining that the pipeline 540A is designated to process tile rows 126 of the first row, designates the pipeline 540B for generating (e.g., reproducing) tile rows 126 of the second row. The pixel processor 140, concurrently with using the pipeline 540A to generate the tile row 126AA, uses the pipeline 540B to process the tile row header information 182AB, the tile row coefficient information 184AB, and the slice information 186A to generate (e.g., reproduce) the tile row 126AB. In a particular aspect, the pixel processor 140 provides the tile row 126AB to the display device 114.

Optionally, in some embodiments, processing of a row is delayed relative to processing of a prior row. For example, the pipeline 540B to process the second row is delayed (e.g., by two coding units) relative to the pipeline 540A to process the first row. To illustrate, an initial portion of the tile row 126AA is generated by the pipeline 540A prior to generation of an initial portion of the tile row 126AB by the pipeline 540B. The delay enables a portion (e.g., the initial portion) of the tile row 126AB to be generated based at least in part on a corresponding portion (e.g., the initial portion) of the tile row 126AA that has already been generated.

The pixel processor 140 continues processing data of the slice information buffer 502, the tile row header information buffer 506, and the tile row coefficient information buffer 508 to generate tile rows 126. For example, the pixel processor 140 retrieves the tile row header information 182BA, the tile row coefficient information 184BA, and the slice information 186B from the tile row header information buffer 506, the tile row coefficient information buffer 508, and the slice information buffer 502, respectively. In a particular embodiment, the pixel processor 140, in response to determining that the tile row header information 182BA indicates that the tile row header information 182BA is associated with the first row (e.g., Row 0) of the image frame 120 and that the pipeline 540A is designated for generating (e.g., reproducing) tile rows 126 of the first row, uses the pipeline 540A to process the tile row header information 182BA, the tile row coefficient information 184BA, and the slice information 186B to generate (e.g., reproduce) the tile row 126BA. In a particular aspect, the pixel processor 140 provides the tile row 126BA to the display device 114.

The pixel processor 140 can thus process the slice information 186B that has been fetched and stored in the slice information buffer 502, without the latency associated with parsing the tile row header information 182BA retrieved from the tile row header information buffer 506 to detect crossing the slice boundary 148 to the slice 124B corresponding to the slice identifier 176B and then using the slice identifier 176B to retrieve the slice information 186B from the off-chip memory 144. The buffered slice information 186B reduces delay associated with using the slice information 186B at the slice boundary 148 between the tile row 126AA of the tile 122A and the tile row 126BA of the tile 122B.

Similarly, the pixel processor 140 retrieves the tile row header information 182BB, the tile row coefficient information 184BB, and the slice information 186C from the tile row header information buffer 506, the tile row coefficient information buffer 508, and the slice information buffer 502, respectively. In a particular embodiment, the pixel processor 140, in response to determining that the tile row header information 182BB indicates that the tile row header information 182BB is associated with the second row (e.g., Row 1) of the image frame 120 and determining that the pipeline 540B is designated to process tile rows 126 of the second row and concurrently with using the pipeline 540A to generate the tile row 126BA, uses the pipeline 540B to process the tile row header information 182BB, the tile row coefficient information 184BB, and the slice information 186C to generate (e.g., reproduce) the tile row 126BB. In a particular aspect, the pixel processor 140 provides the tile row 126BB to the display device 114.

Optionally, in some embodiments, the pixel processor 140 performs progressive display in which the tile row 126AA, tile row 126AB, the tile row 126BA, and the tile row 126BB are provided to the display device 114 prior to generating remaining tile rows of the image frame 120. A technical advantage of the progressive display includes reduced display latency associated with displaying at least a portion of the image frame 120 to the user 116. Having the slice information 186 in the slice information buffer 502 further reduces display latency associated with displaying at least a portion of the image frame 120 to the user 116. Reconstruction of a portion of the image frame 120 is described herein. In each of the examples of FIGS. 5B and 6B, as the data is retrieved from the buffers 502, 504, 506, and 508 and used to generate tile rows 126, the buffers 502, 504, 506, and 508 are populated with additional data (e.g., corresponding to subsequent tile rows 126 based on a selected order) for processing by the one or more pipelines 540 to reconstruct the entire image frame 120, as described with reference to FIGS. 5A and 6A.

Referring to FIG. 7, an example 700 is shown in which multiple slices 124 include a respective portion of a tile row of the image frame 120 of the system 100 of FIG. 1, in accordance with some examples of the present disclosure. For example, the tile row 126BA includes a tile row portion (TRP) 726A, a tile row portion 726B, and a tile row portion 726C. It should be understood that a tile row 126 including three tile row portions 726 is provided as an illustrative example, in another example the tile row 126 can include fewer than three or more than three tile row portions 726.

The tile row portion 726A, the tile row portion 726B, and the tile row portion 126C correspond to a slice 124B, a slice 124C, and a slice 124D, respectively. Each of the slices 124B, 124C, and 124D includes a representation of the corresponding tile row portion 726. For example, the slice 124B includes a representation of the tile row portion 726A. A representation of a tile row portion 726 includes tile row portion header information 782 and tile row portion coefficient information 784. For example, the representation of the tile row portion 726A includes tile row portion header information 782A and tile row portion coefficient information 784A. The tile row portion header information 782A includes the slice identifier 176B of the slice 124B and the tile identifier 178B of the tile 122B that includes the tile row 126BA.

The tile row portion header information 782A includes tile row portion information. In some aspects, the tile row portion information indicates tile row portion dimensions (e.g., a count of coding unit columns included in the tile row portion 726A), a tile row portion position (e.g., a tile row portion column index indicating a position of the tile row portion 726A in the tile row 126BA), tile row information of the tile row 126BA, compression parameters (e.g., a compression method indicator, quantization parameters, coding tables, etc.), color space indicator (e.g., RGB or YCbCr), bit depth, prediction parameters, error correction and validation parameters, or a combination thereof.

In a particular embodiment, the tile row portion coefficient information 784A represents image data of at least the tile row portion 726A. In a particular aspect, a DCT operation is performed (e.g., at an encoder device) on at least a portion of the entire image frame 120 that includes the tile row portion 726A to generate coefficients, and the tile row portion coefficient information 784A is based on the coefficients. For example, the tile row portion coefficient information 784A includes at least some of the coefficients or quantized versions of the coefficients.

The entropy decoder 138 of FIG. 1, in response to receiving the representation of a slice 124 including a representation of a tile row portion 726, stores the representation of the tile row portion 726 in the off-chip memory 144. For example, the entropy decoder 138 stores the tile row portion header information 782A at a first location of the off-chip memory 144 and the tile row portion coefficient information 784A at a second location of the off-chip memory 144.

The entropy decoder 138, in response to receiving a representation of a slice 124 that corresponds to a tile row portion 726 of a tile row 126, generates (or updates) a control entry 152 for the tile row 126. For example, the entropy decoder 138, in response to receiving the representation of the slice 124B that corresponds to the tile row portion 726A, generates a control entry 152BA for the tile row 126BA. The control entry 152BA includes tile row header location data 162BA indicating at least the first location in the off-chip memory 144 of the tile row portion header information 782A. The control entry 152VA includes tile row coefficient location data 164BA indicating at least the second location in the off-chip memory 144 of the tile row portion coefficient information 784A. The entropy decoder 138 copies the tile identifier 178B indicated in the tile row portion header information 782A to the control entry 152BA. The control entry 152BA also indicates the slice identifier 176B that is indicated in the tile row portion header information 782A.

As another example, the slice 124C includes a representation of the tile row portion 726B. The representation of the tile row portion 726B includes tile row portion header information 782B and tile row portion coefficient information 784B. The tile row portion header information 782B includes the slice identifier 176C of the slice 124C and the tile identifier 178B of the tile 122B that includes the tile row 126BA. The entropy decoder 138 stores the tile row portion header information 782B at a first particular location of the off-chip memory 144 and tile row portion coefficient information 784B at a second particular location of the off-chip memory 144.

The entropy decoder 138, in response to receiving the representation of the slice 124C that corresponds to the tile row portion 726B of the tile row 126BA and determining that the control storage unit 150 includes the control entry 152BA for the tile row 126BA, updates the control entry 152BA. For example, the entropy decoder 138 adds, to the tile row header location data 162BA, the first particular location in the off-chip memory 144 of the tile row portion header information 782B. The control entry 152 adds, to the tile row coefficient location data 164BA, the second particular location in the off-chip memory 144 of the tile row portion coefficient information 784B. The entropy decoder 138 updates the control entry 152BA to indicate the slice identifier 176C that is indicated in the tile row portion header information 782B.

In embodiments in which multiple slices can correspond to respective portions of a tile row 126, a control entry 152 can indicate slice identifiers of one or more slices. For example, in some embodiments, the control entry 152BA includes a slice identifier (e.g., the slice identifier 176B) of an initial slice of the tile row 126BA and a count of slices detected in the tile row 126BA, and the entropy decoder 138 updates the count of slices from a first value (e.g., 1) indicating a single slice to a second value (e.g., 2) indicating two slices. As another example, in some embodiments, the control entry 152BA includes a first slice identifier (e.g., the slice identifier 176B) of an initial slice of the tile row 126BA and a second slice identifier of an end slice of the tile row 126BA, and the entropy decoder 138 updates the second slice identifier to include the slice identifier 176C.

Similarly, the entropy decoder 138 processes the representation of the slice 124D (e.g., tile row portion header information 782C and tile row portion coefficient information 784C). For example, the entropy decoder 138 stores the representation of the slice 124D in the off-chip memory 144 and updates the control entry 152BA. To illustrate, the entropy decoder 138 updates the tile row header location data 162BA and the tile row coefficient location data 164BA to indicate a location in the off-chip memory 144 of the tile row portion header information 782C and a location in the off-chip memory 144 of the tile row portion coefficient information 784C.

The entropy decoder 138 updates the control entry 152BA to indicate the slice identifier 176D. In some embodiments, the control entry 152 includes a slice identifier (e.g., the slice identifier 176B) of an initial slice of the tile row 126BA and a count of slices detected in the tile row 126BA, and the entropy decoder 138 updates the count of slices from the second value (e.g., 2) indicating two slices to a third value (e.g., 3) indicating three slices. In some embodiments, the control entry 152 includes a first slice identifier (e.g., the slice identifier 176B) of an initial slice of the tile row 126BA and a second slice identifier of an end slice of the tile row 126BA, and the entropy decoder 138 updates the second slice identifier from the slice identifier 176C to the slice identifier 176D.

The pixel processor 140 retrieves control entries 152 in left-to-right and top-to-bottom order, as described with reference to FIGS. 5A and 6A. The pixel processor 140, in response to retrieving the control entry 152BA for the tile row 126BA from the off-chip memory 144, copies the tile identifier 178B indicated in the control entry 152BA to a particular slot of the tile identifier buffer 504. The pixel processor 140 uses the slice identifier 176B, the slice identifier 176C, and the slice identifier 176D indicated in the control entry 152BA to copy the slice information 186B, the slice information 186C, and the slice information 186D, respectively, from the off-chip memory 144 to particular slots of the slice information buffer 502.

In a particular aspect, the pixel processor 140 updates the tile identifier buffer 504 to indicate an association between the particular slot of the tile identifier buffer 504 and the particular slots of the slice information buffer 502. For example, the particular slot of the tile identifier buffer 504 indicates the particular slots of the slice information buffer 502. To illustrate, the particular slot of the tile identifier buffer 504 is associated with a first count of slots from a start slot of the slice information buffer 502 (e.g., storing the slice information 186B) to an end slot of the slice information buffer 502 (e.g., storing the slice information 186D). In a particular embodiment, the particular slot of the tile identifier buffer 504 indicates a slot index of the start slot and the first count. In another embodiment, the particular slot of the tile identifier indicates a slot index of the start slot and a slot index of the end slot.

The pixel processor 140 uses the tile row header location data 162BA indicated in the control entry 152BA to copy tile row header information 182BA (e.g., the tile row portion header information 782A, the tile row portion header information 782B, and the tile row portion header information 782C) from the off-chip memory 144 to one or more particular slots of the tile row header information buffer 506. The pixel processor 140 uses the tile row coefficient location data 164BA indicated in the control entry 152BA to copy tile row coefficient information 184BA (e.g., the tile row portion coefficient information 784A, the tile row portion coefficient information 784B, and the tile row portion coefficient information 784C) from the off-chip memory 144 to one or more particular slots of the tile row coefficient information buffer 508. In a particular aspect, the pixel processor 140 updates the tile identifier buffer 504 to indicate an association between the particular slot of the tile identifier buffer 504 and the one or more particular slots of the tile row header information buffer 506, an association between the particular slot of the tile identifier buffer 504 and the one or more particular slots of the tile row coefficient information buffer 508, or both.

The pixel processor 140 processes data of the slice information buffer 502, the tile row header information buffer 506, and the tile row coefficient information buffer 508 to generate tile rows 126, as described with reference to FIGS. 5B and 6B. For example, the pixel processor 140, to generate (e.g., reproduce) the tile row portion 726A, uses a pipeline 540 of FIG. 5B or FIG. 6B to process the tile row header information 182BA (e.g., the tile row portion header information 782A), the tile row coefficient information 184BA (e.g., the tile row portion coefficient information 784A), and the slice information 186B retrieved from the tile row header information buffer 506, the tile row coefficient information buffer 508, and the slice information buffer 502, respectively. As another example, the pixel processor 140, to generate the tile row portion 726B, uses the pipeline 540 to process the tile row header information 182BA (e.g., the tile row portion header information 782B), the tile row coefficient information 184BA (e.g., the tile row portion coefficient information 784B), and the slice information 186C retrieved from the tile row header information buffer 506, the tile row coefficient information buffer 508, and the slice information buffer 502, respectively.

In another example, the pixel processor 140, to generate the tile row portion 726C, uses the pipeline 540 to process the tile row header information 182BA (e.g., the tile row portion header information 782C), the tile row coefficient information 184BA (e.g., the tile row portion coefficient information 784C), and the slice information 186D retrieved from the tile row header information buffer 506, the tile row coefficient information buffer 508, and the slice information buffer 502, respectively. In a particular aspect, the pixel processor 140 generates (e.g., reproduces) the tile row 126BA based on a combination (e.g., concatenation) of the tile row portion 726A, the tile row portion 726B, and the tile row portion 726C. The pixel processor 140 can thus process the slice information 186B, C, D that has been fetched and stored in the slice information buffer 502 to generate the corresponding tile row 126BA.

Referring to FIG. 8, a diagram 800 of an illustrative aspect of a control entry format 852 of a control entry 152 of the system 100 of FIG. 1, in accordance with some examples of the present disclosure. For example, one or more control entries 152 of the control storage unit 150 comply with the control entry format 852. To illustrate, a control entry 152 of a tile row 126 complies with the control entry format 852. In a particular aspect, the control entry format 852 has a 32 byte length. In a particular aspect, the control entry format 852 complies with a video compression standard, such as a HEVC standard.

The control entry format 852 includes a tile row header location data field 862, a tile row coefficient location data field 864, a tile identifier field 878, and a slice identifier data field 876. The tile identifier field 878 indicates a tile identifier 178 of a tile 122 that includes the tile row 126.

The slice identifier data field 876 indicates one or more slice identifiers 176. In an example 802, the slice identifier data field 876 includes a slice identifier field 832. The slice identifier field 832 indicates a slice identifier 176. In the example 802, the slice identifier data field 876 indicates a single slice. To illustrate, the slice identifier field 832 can indicate the slice identifier 176B of the slice 124B to indicate that the slice 124B includes the tile row 126.

An example 804 and an example 806 are provided as illustrative examples of a format of the slice identifier data field 876 that can be used to indicate multiple slices that include corresponding portions of a tile row 126, as described with reference to FIG. 7. In the example 804, the slice identifier data field 876 includes a slice identifier field 832 and a slice identifier field 834. In the example 804, the slice identifier data field 876 can indicate one or more slices. To illustrate, each of the slice identifier field 832 and the slice identifier field 834 can include the same slice identifier (e.g., the slice identifier 176B) to indicate a single slice (e.g., the slice 124B) to indicate that the single slice (e.g., the slice 124B) includes the tile row 126. Alternatively, the slice identifier field 832 can include a first slice identifier (e.g., the slice identifier 176B) of a first slice (e.g., the slice 124B) and the slice identifier field 834 can include a second slice identifier (e.g., the slice identifier 176D) of an end slice (e.g., the slice 124D) to indicate consecutive slices (e.g., the slice 124B, the slice 124C, and the slice 124D) from the first slice to the end slice. Each of the consecutive slices includes a corresponding portion of the tile row 126, as described with reference to FIG. 7.

In the example 806, the slice identifier data field 876 includes a slice identifier field 832 and a count field 836. In the example 806, the slice identifier data field 876 can indicate one or more slices. To illustrate, the slice identifier field 832 can include a first slice identifier (e.g., the slice identifier 176B) of a first slice (e.g., the slice 124B) and the count field 836 can indicate a count of one or more additional slices. In an example, the count field 836 can have a first value (e.g., 0) to indicate that no additional slices are indicated. Alternatively, the count field 836 can include a second value (e.g., 2) to indicate that the first slice (e.g., the slice 124B) and a corresponding count of consecutive additional slices (e.g., the slice 124C and the slice 124D) are indicated. Each of the slices (e.g., the slice 124B, the slice 124C, and the slice 124D) includes a corresponding portion of the tile row 126, as described with reference to FIG. 7.

The tile row header location data field 862 indicates tile row header location data 162. In a particular aspect, the tile row header location data field 862 includes a memory address field 812 (e.g., a header memory address field) and a size field 814 (e.g., a header size field). The memory address field 812 indicates a starting location in the off-chip memory 144 of tile row header information 182 and the size field 814 indicates a size of the tile row header information 182.

Although, the tile row header location data field 862 is illustrated as including a single memory address field 812 and a corresponding size field 814, in other examples the tile row header location data field 862 can include multiple memory address fields 812 and corresponding size fields 814. For example, the tile row header information 182 can be stored in multiple non-consecutive memory portions of the off-chip memory 144 and a particular memory address field 812 can indicate a starting location of a respective memory portion and a corresponding size field 814 can indicate a size of the memory portion.

In some embodiments, the tile row header location data field 862 includes multiple memory address fields 812 and corresponding size fields 814 that are associated with multiple tile row portions. For example, at least a first pair of memory address field 812 and size field 814 indicate a location of a tile row portion header information 782A of FIG. 7, at least a second pair of memory address field 812 and size field 814 indicate a location of a tile row portion header information 782B, and at least a third pair of memory address field 812 and size field 814 indicate a location of a tile row portion header information 782C.

The tile row coefficient location data field 864 indicates tile row coefficient location data 164. In a particular aspect, the tile row coefficient location data field 864 includes a memory address field 822 (e.g., a coefficient memory address field) and a size field 824 (e.g., a coefficient size field). The memory address field 822 indicates a starting location in the off-chip memory 144 of tile row coefficient information 184 and the size field 824 indicates a size of the tile row coefficient information 184.

Although, the tile row coefficient location data field 864 is illustrated as including a single memory address field 822 and a corresponding size field 824, in other examples the tile row coefficient location data field 864 can include multiple memory address fields 822 and corresponding size fields 824. For example, the tile row coefficient information 184 can be stored in multiple non-consecutive memory portions of the off-chip memory 144 and a particular memory address field 822 can indicate a starting location of a respective memory portion and a corresponding size field 824 can indicate a size of the memory portion.

In some embodiments, the tile row coefficient location data field 864 includes multiple memory address fields 822 and corresponding size fields 824 that are associated with multiple tile row portions. For example, at least a first pair of memory address field 822 and size field 824 indicate a location of a tile row portion coefficient information 784A of FIG. 7, at least a second pair of memory address field 822 and size field 824 indicate a location of a tile row portion coefficient information 784B, and at least a third pair of memory address field 822 and size field 824 indicate a location of a tile row portion coefficient information 784C.

A technical advantage of the slice identifier data field 876 of example 802 includes a smaller size (e.g., fewer bits) than the slice identifier data field 876 of the example 804 and the slice identifier data field 876 of the example 806. A technical advantage of the slice identifier data field 876 of the example 804 and the slice identifier data field 876 of the example 806 includes enabling support of a slice 124 corresponding to a tile row portion or an entire tile row.

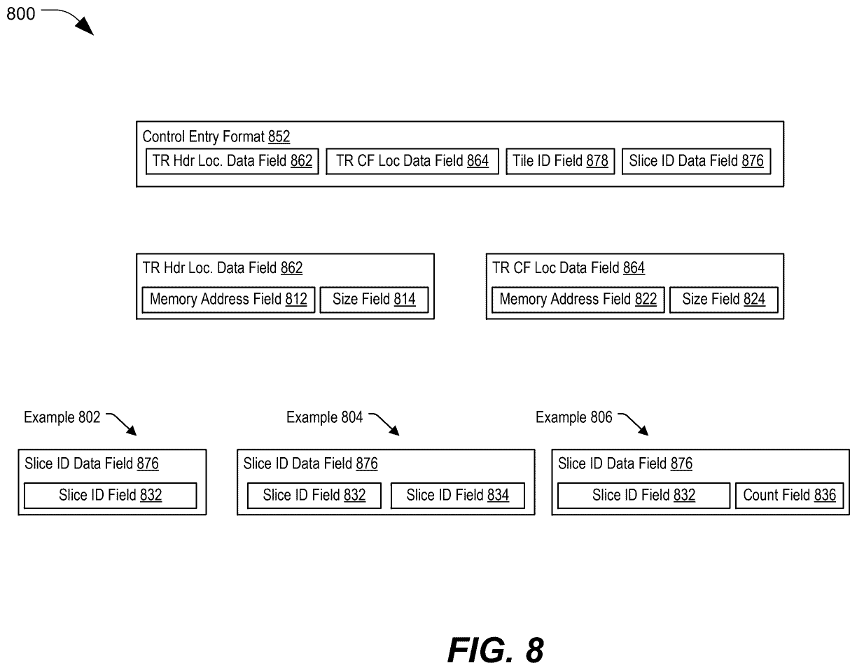

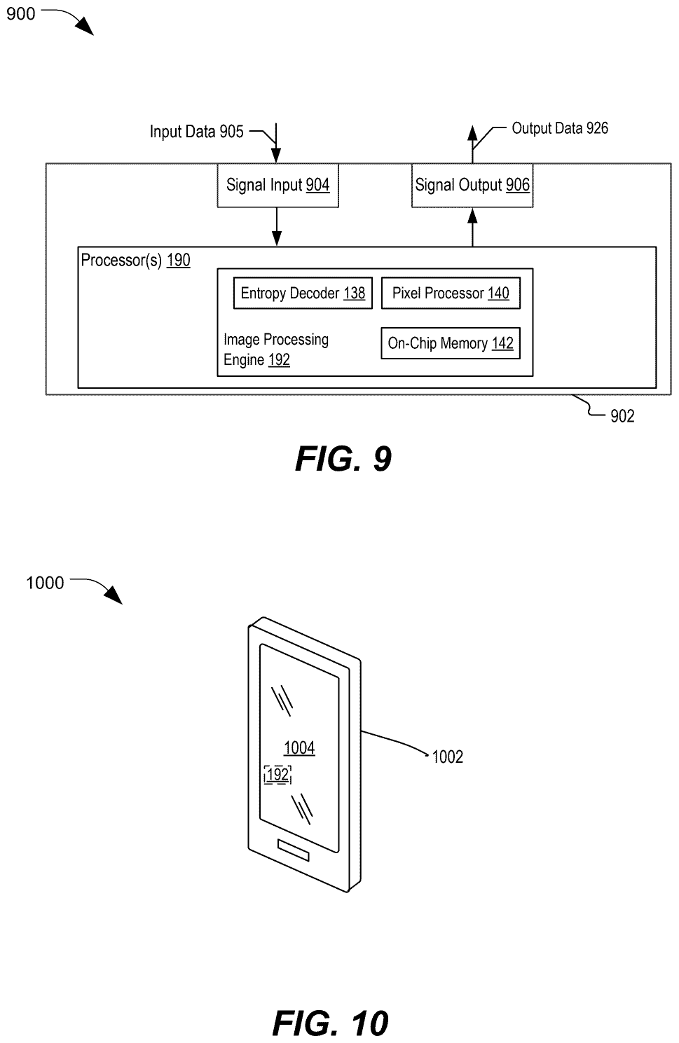

FIG. 9 depicts an implementation 900 of the device 102 as an integrated circuit 902 that includes the one or more processors 190. The one or more processors 190 include the image processing engine 192 that includes the entropy decoder 138, the pixel processor 140, and the on-chip memory 142. In a particular aspect, the integrated circuit 902 is coupled to an off-chip memory 144, the display device 114 of FIG. 1, or both. The integrated circuit 902 also includes a signal input 904, such as one or more bus interfaces, to enable input data 905 to be received for processing. In a particular aspect, the input data 905 includes the bitstream 105 received from a bitstream source 104 of FIG. 1. In another aspect, the input data 905 includes data retrieved from the off-chip memory 144, such as a control entry 152, slice information 186, tile row header information 182, tile row coefficient information 184 of FIG. 1, or a combination thereof.

The integrated circuit 902 also includes a signal output 906, such as a bus interface, to enable sending of output data 926. In a particular aspect, the output data 926 includes data sent to the off-chip memory 144, such as a control entry 152, slice information 186, slice header data 196, a slice identifier 176, tile row header information 182, tile row coefficient information 184 of FIG. 1, or a combination thereof. In a particular aspect, the output data 926 includes one or more tile rows 126 of the image frame 120 sent to the display device 114 of FIG. 1.

The integrated circuit 902 enables implementation of storing slice information in an image data control storage unit as a component in a system that includes a display, such as a mobile phone or tablet as depicted in FIG. 10, a wearable electronic device as depicted in FIG. 11, a mixed reality or augmented reality glasses device as depicted in FIG. 12, a virtual reality, mixed reality, or augmented reality headset as depicted in FIG. 13, or a vehicle as depicted in FIG. 14 or FIG. 15.

FIG. 10 depicts an implementation 1000 in which the device 102 includes a mobile device 1002, such as a phone or tablet, as illustrative, non-limiting examples. The mobile device 1002 includes a display screen 1004. Components of the processor(s) 190, including the image processing engine 192, are integrated in the mobile device 1002 and are illustrated using dashed lines to indicate internal components that are not generally visible to a user of the mobile device 1002. In a particular example, the image processing engine 192 operates to, based on a bitstream 105, generate a control entry 152 that includes a slice identifier 176. Additionally, or alternatively, the image processing engine 192 operates to retrieve the control entry 152 and use the slice identifier 176 indicated in the control entry 152 to fetch slice information 186 to populate a slice information buffer 502 which enables the image processing engine 192 to use the slice information 186 stored in the slice information buffer 502 to generate a tile row 126 of an image frame 120.

In some examples, one or more tile rows 126 of the image frame 120, are then processed to perform one or more operations at the mobile device 1002, such as to launch a graphical user interface or otherwise display the one or more tile rows 126 at the display screen 1004. In a particular aspect, the display screen 1004 includes the display device 114 of FIG. 1.

FIG. 11 depicts an implementation 1100 in which the device 102 includes a wearable electronic device 1102, illustrated as a “smart watch. ” The image processing engine 192 is integrated into the wearable electronic device 1102.

In a particular example, the image processing engine 192 operates to, based on a bitstream 105, generate a control entry 152 that includes a slice identifier 176. Additionally, or alternatively, the image processing engine 192 operates to retrieve the control entry 152 and use the slice identifier 176 indicated in the control entry 152 to fetch slice information 186 to populate a slice information buffer 502 which enables the image processing engine 192 to use the slice information 186 stored in the slice information buffer 502 to generate a tile row 126 of an image frame 120. In some examples, one or more tile rows 126 of the image frame 120 are then processed to perform one or more operations at the wearable electronic device 1102, such as to launch a graphical user interface or otherwise display the one or more tile rows 126 at a display screen 1104 of the wearable electronic device 1102. In a particular aspect, the display screen 1104 includes the display device 114 of FIG. 1.

In a particular example, the wearable electronic device 1102 includes a haptic device that provides a haptic notification (e.g., vibrates) in response to generation of the one or more tile rows 126. For example, the haptic notification can cause a user to look at the wearable electronic device 1102 to see the one or more tile rows 126 displayed at the display screen 1104. The wearable electronic device 1102 can thus alert a user that at least a portion of the image frame 120 is available.

FIG. 12 depicts an implementation 1200 in which the device 102 includes a portable electronic device that corresponds to augmented reality or mixed reality glasses 1202. The glasses 1202 include a holographic projection unit 1204 configured to project visual data onto a surface of a lens 1206 or to reflect the visual data off of a surface of the lens 1206 and onto the wearer's retina. The image processing engine 192 is integrated into the glasses 1202. The image processing engine 192 operates to, based on a bitstream 105, generate a control entry 152 that includes a slice identifier 176. Additionally, or alternatively, the image processing engine 192 operates to retrieve the control entry 152 and use the slice identifier 176 indicated in the control entry 152 to fetch slice information 186 to populate a slice information buffer 502 which enables the image processing engine 192 to use the slice information 186 stored in the slice information buffer 502 to generate a tile row 126 of an image frame 120.

In a particular example, the holographic projection unit 1204 is configured to display one or more tile rows 126 of the image frame 120. For example, the one or more tile rows 126 can be superimposed on the user's field of view. In an illustrative implementation, the holographic projection unit 1204 is configured to display the one or more tile rows 126 at a particular position that is based on a detected audio event or environment. In a particular aspect, the holographic projection unit 1204 corresponds to the display device 114 of FIG. 1.

FIG. 13 depicts an implementation 1300 in which the device 102 includes a portable electronic device that corresponds to a virtual reality, mixed reality, or augmented reality headset 1302. The image processing engine 192 is integrated into the headset 1302.

In a particular example, the image processing engine 192 operates to, based on a bitstream 105, generate a control entry 152 that includes a slice identifier 176. Additionally, or alternatively, the image processing engine 192 operates to retrieve the control entry 152 and use the slice identifier 176 indicated in the control entry 152 to fetch slice information 186 to populate a slice information buffer 502 which enables the image processing engine 192 to use the slice information 186 stored in the slice information buffer 502 to generate a tile row 126 of an image frame 120.

A visual interface device is positioned in front of the user's eyes to enable display of augmented reality, mixed reality, or virtual reality images or scenes to the user while the headset 1302 is worn. In a particular example, the visual interface device is configured to display one or more tile rows 126 of the image frame 120 generated by the image processing engine 192. In a particular aspect, the visual interface device corresponds to the display device 114 of FIG. 1.

FIG. 14 depicts an implementation 1400 in which the device 102 corresponds to, or is integrated within, a vehicle 1402, illustrated as a manned or unmanned aerial device (e.g., a package delivery drone). The image processing engine 192 is integrated into the vehicle 1402.

In a particular example, the image processing engine 192 operates to, based on a bitstream 105, generate a control entry 152 that includes a slice identifier 176. Additionally, or alternatively, the image processing engine 192 operates to retrieve the control entry 152 and use the slice identifier 176 indicated in the control entry 152 to fetch slice information 186 to populate a slice information buffer 502 which enables the image processing engine 192 to use the slice information 186 stored in the slice information buffer 502 to generate a tile row 126 of an image frame 120. In a particular example, the image frame 120 represents assembly instructions of a product that is being delivered using the vehicle 1402. In a particular aspect, the image frame 120 is displayed on a display screen of the vehicle 1402. In a particular aspect, the display screen of the vehicle 1402 corresponds to the display device 114 of FIG. 1.

FIG. 15 depicts another implementation 1500 in which the device 102 corresponds to, or is integrated within, a vehicle 1502, illustrated as a car. The vehicle 1502 includes the processor(s) 190 including the image processing engine 192.

In a particular example, the image processing engine 192 operates to, based on a bitstream 105, generate a control entry 152 that includes a slice identifier 176. Additionally, or alternatively, the image processing engine 192 operates to retrieve the control entry 152 and use the slice identifier 176 indicated in the control entry 152 to fetch slice information 186 to populate a slice information buffer 502 which enables the image processing engine 192 to use the slice information 186 stored in the slice information buffer 502 to generate a tile row 126 of an image frame 120. One or more tile rows 126 of the image frame 120 are provided to a display 1520 of the vehicle 1502. In a particular aspect, the display 1520 corresponds to the display device 114 of FIG. 1.

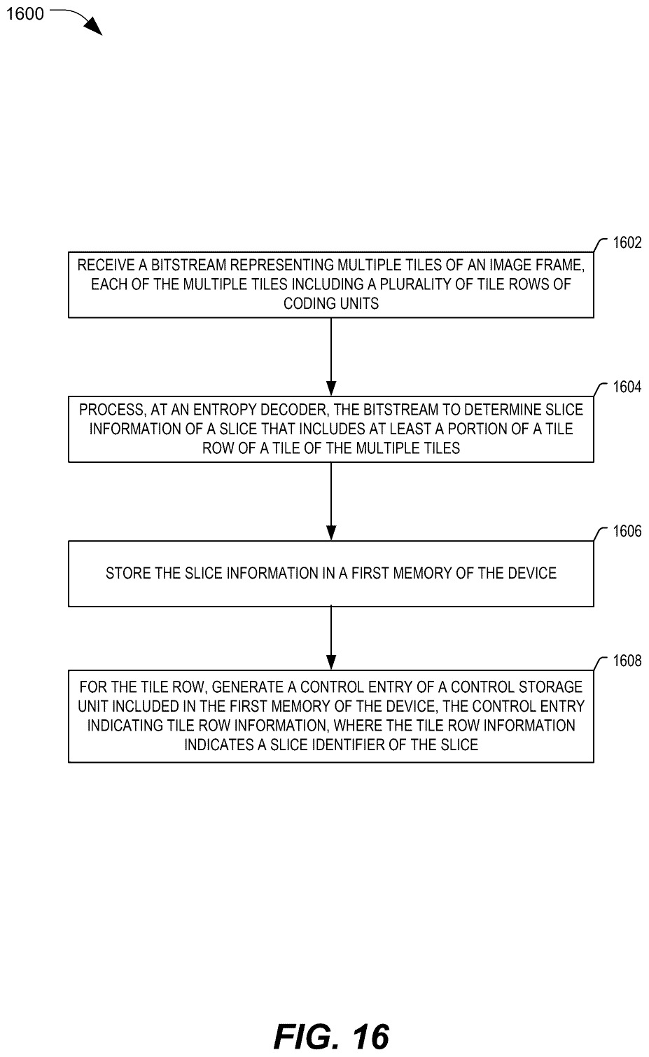

Referring to FIG. 16, a particular implementation of a method 1600 of storing slice information in an image data control storage unit is shown. In a particular aspect, one or more operations of the method 1600 are performed by at least one of the entropy decoder 138, the image processing engine 192, the one or more processors 190, the device 102, the system 100 of FIG. 1, or a combination thereof.

The method 1600 includes, at 1602, receiving a bitstream representing multiple tiles of an image frame, each of the multiple tiles including a plurality of tile rows of coding units. For example, the entropy decoder 138 of FIG. 1 receives a bitstream 105 representing multiple tiles 122 of an image frame 120. Each of the tiles 122 includes a plurality of tile rows 126 of coding units, as described with reference to FIGS. 1 and 2.

The method 1600 includes, at 1604, processing, at an entropy decoder, the bitstream to determine slice information of a slice that includes at least a portion of a tile row of a tile of the multiple tiles. For example, the entropy decoder 138 of FIG. 1 processes the bitstream 105 to determine the slice header data 196 that includes the slice information 186B of a slice 124B, as described with reference to FIGS. 1 and 3. The slice 124B includes at least a portion of a tile row 126BA of a tile 122B of the tiles 122, as described with reference to FIGS. 1 and 7. In a particular aspect, the slice 124B includes all of the tile row 126BA, as described with reference to FIG. 1. In an alternative aspect, the slice 124B includes the tile row portion 726A of the tile row 126BA, as described with reference to FIG. 7.

The method 1600 includes, at 1606, storing the slice information in a first memory of the device. For example, the entropy decoder 138 of FIG. 1 stores the slice information 186B in the off-chip memory 144, as described with reference to FIGS. 1 and 3.

The method 1600 includes, at 1608, for the tile row, generating a control entry of a control storage unit included in the first memory of the device, the control entry indicating tile row information, where the tile row information indicates a slice identifier of the slice. For example, the entropy decoder 138 of FIG. 1, for the tile row 126BA, generates a control entry 152 BA of a control storage unit 150 included in the off-chip memory 144 of the device 102, as described with reference to FIGS. 4B and 7. The control entry 152BA indicates tile row information. For example, the tile row information indicates the slice identifier 176B of the slice 124B, as described with reference to FIGS. 4B and 7.

The method 1600 thus enables the slice identifier 176B to be available in the on-chip memory 142 when the pixel processor 140 fetches the control entry 152BA of the tile row 126BA and uses the control entry 152BA to populate the slice information buffer 502. Having the slice identifier 176 in the control entry 152 that is used to populate the slice information buffer 502 stored in the on-chip memory 142 can reduce reproduction latency and hence display latency associated with displaying at least a portion of the image frame 120.

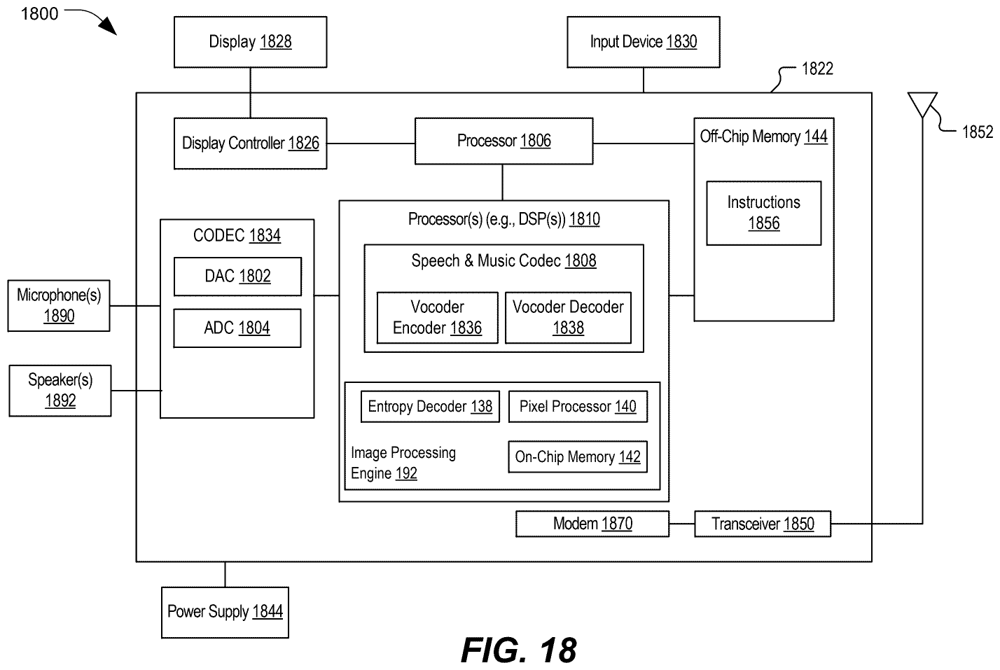

The method 1600 of FIG. 16 may be implemented by a field-programmable gate array (FPGA) device, an application-specific integrated circuit (ASIC), a processing unit, such as a central processing unit (CPU), a digital signal processor (DSP), a controller, another hardware device, firmware device, or any combination thereof. As an example, the method 1600 of FIG. 16 may be performed by a processor that executes instructions, such as described with reference to FIG. 18.

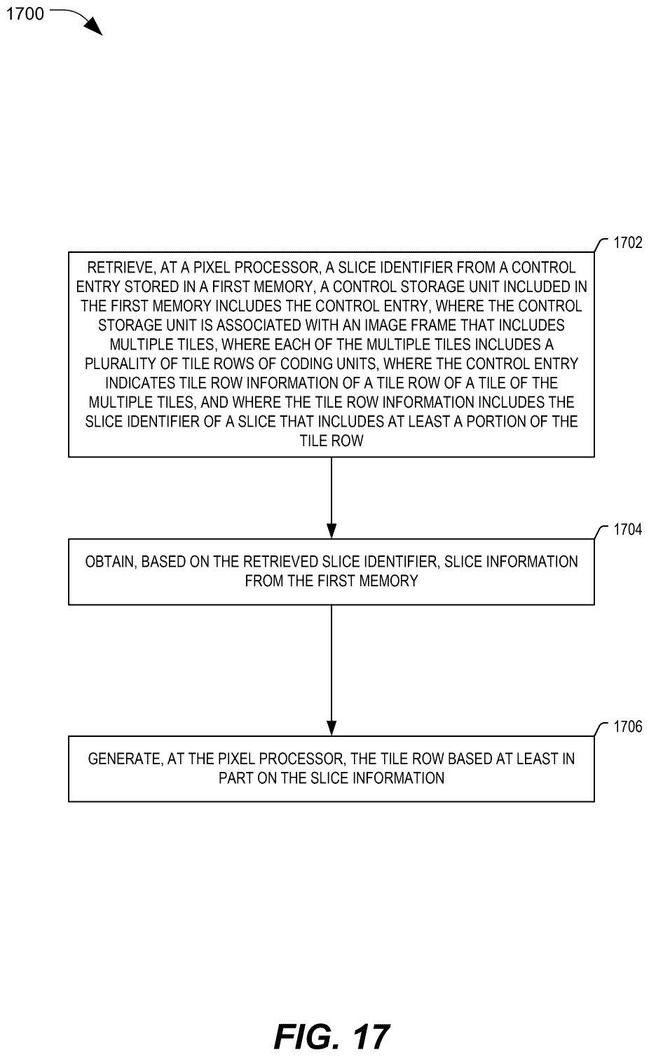

Referring to FIG. 17, a particular implementation of a method 1700 of using stored slice information in an image data control storage unit is shown. In a particular aspect, one or more operations of the method 1700 are performed by at least one of the pixel processor 140, the image processing engine 192, the one or more processors 190, the device 102, the system 100 of FIG. 1, or a combination thereof.

The method 1700 includes, at 1702, retrieving, at a pixel processor, a slice identifier from a control entry stored in a first memory, a control storage unit included in the first memory includes the control entry, where the control storage unit is associated with an image frame that includes multiple tiles, where each of the multiple tiles includes a plurality of tile rows of coding units, where the control entry indicates tile row information of a tile row of a tile of the multiple tiles, and where the tile row information includes the slice identifier of a slice that includes at least a portion of the tile row. For example, the pixel processor 140 of FIG. 1 retrieves the slice identifier 176B from the control entry 152BA of the control storage unit 150 stored in the off-chip memory 144, as described with reference to FIGS. 5A and 6A. The control storage unit 150 is associated with an image frame 120 that includes multiple tiles 122. Each of the tiles 122 includes a plurality of tile rows 126 of coding units, as described with reference to FIG. 1. The control entry 152BA indicates tile row information of a tile row 126BA of a tile 122B of the tiles 122. The tile row information includes the slice identifier 176B of the slice 124B that includes at least a portion of the tile row 126BA. In a particular aspect, the slice 124B includes all of the tile row 126BA, as described with reference to FIG. 1. In an alternative aspect, the slice 124B includes a tile row portion 726A of the tile row 126BA, as described with reference to FIG. 7.

The method 1700 includes, at 1704, obtaining, based on the retrieved slice identifier, slice information from the first memory. For example, the pixel processor 140 of FIG. 1 obtains, based on the slice identifier 176B retrieved from the control entry 152BA stored in the off-chip memory 144, the slice information 186B from the off-chip memory 144, as described with reference to FIGS. 5A, 6A, and 7.

The method 1700 includes, at 1706, generating, at the pixel processor, the tile row based at least in part on the slice information. For example, the pixel processor 140 of FIG. 1 generates the tile row 126BA based at least in part on the slice information 186B, as described with reference to FIGS. 5B, 6B, and 7.

The method 1700 thus enables the pixel processor 140 to have access to the slice identifier 176B in the on-chip memory 142 when the pixel processor 140 fetches the control entry 152BA of the tile row 126BA and uses the control entry 152BA to populate the slice information buffer 502. Having the slice identifier 176 in the control entry 152 that is used to populate the slice information buffer 452 in the on-chip memory 142 can reduce reproduction latency and hence display latency associated with displaying at least a portion of the image frame 120.

The method 1700 of FIG. 17 may be implemented by a FPGA device, an ASIC, a processing unit, such as a CPU, a DSP, a controller, another hardware device, firmware device, or any combination thereof. As an example, the method 1700 of FIG. 17 may be performed by a processor that executes instructions, such as described with reference to FIG. 18.

Referring to FIG. 18, a block diagram of a particular illustrative implementation of a device is depicted and generally designated 1800. In various implementations, the device 1800 may have more or fewer components than illustrated in FIG. 18. In an illustrative implementation, the device 1800 may correspond to the device 102 of FIG. 1. In an illustrative implementation, the device 1800 may perform one or more operations described with reference to FIGS. 1-17.

In a particular implementation, the device 1800 includes a processor 1806 (e.g., a CPU). The device 1800 may include one or more additional processors 1810 (e.g., one or more DSPs). In a particular aspect, the one or more processors 190 of FIG. 1 correspond to the processor 1806, the processors 1810, or a combination thereof. The processors 1810 may include a speech and music coder-decoder (CODEC) 1808 that includes a voice coder (“vocoder”) encoder 1836, a vocoder decoder 1838, or both. The one or more processors 190 include the image processing engine 192 that includes the entropy decoder 138, the pixel processor 140, and the on-chip memory 142.

The device 1800 may include the off-chip memory 144 and a CODEC 1834. The off-chip memory 144 may include instructions 1856, that are executable by the one or more additional processors 1810 (or the processor 1806) to implement the functionality described with reference to the image processing engine 192. The device 1800 may include the modem 1870 coupled, via a transceiver 1850, to an antenna 1852.

The device 1800 may include a display 1828 coupled to a display controller 1826. One or more speakers 1892 and one or more microphones 1890 may be coupled to the CODEC 1834. The CODEC 1834 may include a digital-to-analog converter (DAC) 1802, an analog-to-digital converter (ADC) 1804, or both. In a particular implementation, the CODEC 1834 may receive analog signals from the microphone(s) 1890, convert the analog signals to digital signals using the analog-to-digital converter 1804, and provide the digital signals to the speech and music codec 1808. The speech and music codec 1808 may process the digital signals. In a particular implementation, the speech and music codec 1808 may provide digital signals to the CODEC 1834. The CODEC 1834 may convert the digital signals to analog signals using the digital-to-analog converter 1802 and may provide the analog signals to the speaker(s) 1892.

In a particular implementation, the device 1800 may be included in a system-in-package or system-on-chip device 1822. In a particular implementation, the off-chip memory 144, the processor 1806, the processors 1810, the display controller 1826, the CODEC 1834, and the modem 1870 are included in the system-in-package or system-on-chip device 1822. In a particular implementation, an input device 1830 and a power supply 1844 are coupled to the system-in-package or the system-on-chip device 1822. Moreover, in a particular implementation, as illustrated in FIG. 18, the display 1828, the input device 1830, the speaker(s) 1892, the microphone(s) 1890, the antenna 1852, and the power supply 1844 are external to the system-in-package or the system-on-chip device 1822. In a particular implementation, each of the display 1828, the input device 1830, the speaker 1892, the microphone(s) 1890, the antenna 1852, and the power supply 1844 may be coupled to a component of the system-in-package or the system-on-chip device 1822, such as an interface or a controller.

The device 1800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for storing control entries associated with an image frame. For example, the means for storing can correspond to the control storage unit 150, the off-chip memory 144, the device 102, the system 100 of FIG. 1, the device 1800, one or more other circuits or components configured to store control entries, or any combination thereof.

The apparatus also includes means for receiving a bitstream representing multiple tiles of the image frame. Each of the multiple tiles includes a plurality of tile rows of coding units. For example, the means for receiving can correspond to the entropy decoder 138, the image processing engine 192, the one or more processors 190, the device 102, the system 100 of FIG. 1, the signal input 904 of FIG. 9, the antenna 1852, the transceiver 1850, the modem 1870, the processor 1806, the one or more processors 1810, the device 1800, one or more other circuits or components configured to receive the bitstream, or any combination thereof.

The apparatus further includes means for generating a control entry of the means for storing control entries, the control entry generated for a tile row of a tile of the multiple tiles. The control entry includes tile row information that indicates a slice identifier of a slice that includes at least a portion of the tile row. For example, the means for generating can correspond to the entropy decoder 138, the image processing engine 192, the one or more processors 190, the device 102, the system 100 of FIG. 1, the signal input 904 of FIG. 9, the antenna 1852, the transceiver 1850, the modem 1870, the processor 1806, the one or more processors 1810, the device 1800, one or more other circuits or components configured to generate a control entry, or any combination thereof.

In conjunction with the described implementations, an apparatus includes means for receiving a bitstream representing multiple tiles of an image frame, each of the multiple tiles including a plurality of tile rows of coding units. For example, the means for receiving can correspond to the entropy decoder 138, the image processing engine 192, the one or more processors 190, the device 102, the system 100 of FIG. 1, the signal input 904 of FIG. 9, the antenna 1852, the transceiver 1850, the modem 1870, the processor 1806, the one or more processors 1810, the device 1800, one or more other circuits or components configured to receive the bitstream, or any combination thereof.

The apparatus also includes means for processing, at an entropy decoder of the device, the bitstream to determine slice information of a slice that includes at least a portion of a tile row of a tile of the multiple tiles. For example, the means for processing can correspond to the entropy decoder 138, the image processing engine 192, the one or more processors 190, the device 102, the system 100 of FIG. 1, the processor 1806, the one or more processors 1810, the device 1800, one or more other circuits or components configured to process the bitstream, or any combination thereof.

The apparatus further includes means for storing the slice information in a first memory of the device. For example, the means for storing can correspond to the entropy decoder 138, the image processing engine 192, the off-chip memory 144, the one or more processors 190, the device 102, the system 100 of FIG. 1, the signal output 906 of FIG. 9, the processor 1806, the one or more processors 1810, the device 1800, one or more other circuits or components configured to store the slice information, or any combination thereof.

The apparatus also includes means for generating, for the tile row, a control entry of a control storage unit included in the first memory of the device, the control entry indicating tile row information, where the tile row information indicates a slice identifier of the slice. For example, the means for generating can correspond to the entropy decoder 138, the image processing engine 192, the one or more processors 190, the device 102, the system 100 of FIG. 1, the processor 1806, the one or more processors 1810, the device 1800, one or more other circuits or components configured to generate the control entry, or any combination thereof.

In conjunction with the described implementations, an apparatus includes means for storing control entries associated with an image frame that includes multiple tiles. Each of the multiple tiles includes a plurality of tile rows of coding units. The means for storing control entries includes a first control entry indicating first tile row information of a first tile row of a first tile of the multiple tiles. The first tile row information indicates a first slice identifier of a first slice that includes at least a portion of the first tile row of the first tile. For example, the means for storing can correspond to the control storage unit 150, the off-chip memory 144, the device 102, the system 100 of FIG. 1, the device 1800, one or more other circuits or components configured to store control entries, or any combination thereof.

The apparatus also includes means for storing first slice information that corresponds to the first slice identifier. For example, the means for storing can correspond to the off-chip memory 144, the device 102, the system 100 of FIG. 1, the device 1800, one or more other circuits or components configured to store control entries, or any combination thereof.

The apparatus further includes means for retrieving the first slice identifier from the first control entry. For example, the means for retrieving can correspond to the pixel processor 140, the image processing engine 192, the one or more processors 190, the device 102, the system 100 of FIG. 1, the signal input 904 of FIG. 9, the processor 1806, the one or more processors 1810, the device 1800, one or more other circuits or components configured to retrieve the slice identifier, or any combination thereof.

The apparatus also includes means for obtaining, based on the retrieved first slice identifier, the first slice information from the means for storing the first slice information. For example, the means for obtaining can correspond to the pixel processor 140, the image processing engine 192, the one or more processors 190, the device 102, the system 100 of FIG. 1, the signal input 904 of FIG. 9, the processor 1806, the one or more processors 1810, the device 1800, one or more other circuits or components configured to obtain the slice information, or any combination thereof.

The apparatus further includes means for generating the first tile row of the first tile based at least in part on the first slice information. For example, the means for generating can correspond to the pixel processor 140, the image processing engine 192, the one or more processors 190, the device 102, the system 100 of FIG. 1, the processor 1806, the one or more processors 1810, the device 1800, one or more other circuits or components configured to generate the tile row, or any combination thereof.

In conjunction with the described implementations, an apparatus includes means for retrieving, at a pixel processor, a slice identifier from a control entry of a control storage unit included in a first memory, the control storage unit associated with an image frame that includes multiple tiles, where each of the multiple tiles includes a plurality of tile rows of coding units, where the control entry indicates tile row information of a tile row of a tile of the multiple tiles, and where the tile row information includes the slice identifier of a slice that includes at least a portion of the tile row. For example, the means for retrieving can correspond to the pixel processor 140, the image processing engine 192, the one or more processors 190, the device 102, the system 100 of FIG. 1, the signal input 904 of FIG. 9, the processor 1806, the one or more processors 1810, the device 1800, one or more other circuits or components configured to retrieve the slice identifier, or any combination thereof.

The apparatus also includes means for obtaining, based on the retrieved slice identifier, slice information from the first memory. For example, the means for obtaining can correspond to the pixel processor 140, the image processing engine 192, the one or more processors 190, the device 102, the system 100 of FIG. 1, the signal input 904 of FIG. 9, the processor 1806, the one or more processors 1810, the device 1800, one or more other circuits or components configured to obtain the slice information, or any combination thereof.

The apparatus further includes means for generating, at the pixel processor of the device, the tile row based at least in part on the slice information. For example, the means for generating can correspond to the pixel processor 140, the image processing engine 192, the one or more processors 190, the device 102, the system 100 of FIG. 1, the processor 1806, the one or more processors 1810, the device 1800, one or more other circuits or components configured to generate the tile row, or any combination thereof.

In some implementations, a non-transitory computer-readable medium (e.g., a computer-readable storage device, such as the off-chip memory 144) includes instructions (e.g., the instructions 1856) that, when executed by one or more processors (e.g., the one or more processors 190, the one or more processors 1810, or the processor 1806), cause the one or more processors to receive a bitstream (e.g., the bitstream 105) representing multiple tiles (e.g., the tiles 122) of an image frame (e.g., the image frame 120), each of the multiple tiles including a plurality of tile rows (e.g., the tile rows 126) of coding units. The instructions, when executed by the one or more processors, also cause the one or more processors to process, at an entropy decoder (e.g., the entropy decoder 138), the bitstream to determine slice information (e.g., the slice information 186) of a slice (e.g., slice identifier 176) that includes at least a portion of a tile row (e.g., a tile row 126 or a tile row portion 726) of a tile (e.g., a tile 122) of the multiple tiles. The instructions, when executed by the one or more processors, further cause the one or more processors to store the slice information in a first memory (e.g., the off-chip memory 144) of the device. The instructions, when executed by the one or more processors, also cause the one or more processors to, for the tile row, generate a control entry (e.g., a control entry 152) of a control storage unit (e.g., the control storage unit 150) included in the first memory of the device, the control entry indicating tile row information, where the tile row information indicates a slice identifier (e.g., a slice identifier 176) of the slice.

In some implementations, a non-transitory computer-readable medium (e.g., a computer-readable storage device, such as the off-chip memory 144) includes instructions (e.g., the instructions 1856) that, when executed by one or more processors (e.g., the one or more processors 190, the one or more processors 1810, or the processor 1806), cause the one or more processors to retrieve, at a pixel processor (e.g., the pixel processor 140), a slice identifier (e.g., a slice identifier 176) from a control entry (e.g., a control entry 152) of a control storage unit (e.g., the control storage unit 150) included in a first memory (e.g., the off-chip memory 144), the control storage unit associated with an image frame (e.g., the image frame 120) that includes multiple tiles (e.g., the tiles 122), where each of the multiple tiles includes a plurality of tile rows (e.g., tile rows 126) of coding units, where the control entry indicates tile row information of a tile row (e.g., a tile row 126) of a tile (e.g., a tile 122) of the multiple tiles, and where the tile row information includes the slice identifier of a slice (e.g., a slice 124) that includes at least a portion of the tile row (e.g., the tile row 126 or a tile row portion 726). The instructions, when executed by the one or more processors, also cause the one or more processors to obtain, based on the retrieved slice identifier, slice information (e.g., slice information 186) from the first memory. The instructions, when executed by the one or more processors, further cause the one or more processors to generate, at the pixel processor, the tile row based at least in part on the slice information.

Particular aspects of the disclosure are described below in sets of interrelated Examples:

According to Example 1, a device includes a first memory configured to include a control storage unit associated with an image frame; and a processor configured to receive a bitstream representing multiple tiles of the image frame, each of the multiple tiles including a plurality of tile rows of coding units; and, for a tile row of a tile of the multiple tiles, generate a control entry of the control storage unit, the control entry including tile row information that indicates a slice identifier of a slice that includes at least a portion of the tile row.

Example 2 includes the device of Example 1, wherein the tile row information indicates the slice identifier of a single slice, and wherein the slice includes at least the tile row.

Example 3 includes the device of Example 1, wherein the tile row information indicates slice identifiers of multiple slices, and wherein each of the multiple slices includes a corresponding portion of the tile row.

Example 4 includes the device of any of Examples 1 to 3, wherein the control entry complies with an entry format that includes a slice identifier field that indicates the slice identifier.

Example 5 includes the device of any of Examples 1 to 4, wherein the control entry complies with an entry format that includes a slice identifier field that indicates the slice identifier and a count field that indicates a count of one or more additional slices, and wherein each of the slice and the one or more additional slices includes a corresponding portion of the tile row.

Example 6 includes the device of any of Examples 1 to 5, wherein each of multiple slices, from the slice to an end slice, includes a corresponding portion of the tile row, and wherein the control entry complies with an entry format that includes a first slice identifier field that indicates the slice identifier of the slice and a second slice identifier field that indicates an end slice identifier of the end slice.

Example 7 includes the device of any of Examples 1 to 6, wherein the control entry complies with an entry format that has a 32 byte length, and wherein the entry format includes: a slice identifier field that indicates the slice identifier; a tile row header location data field that includes tile row header location data, wherein the tile row header location data field includes a header memory address field and a header size field; and a tile row coefficient location data field that includes tile row coefficient location data, wherein the tile row coefficient location data field includes a coefficient memory address field and a coefficient size field.

Example 8 includes the device of any of Examples 1 to 7, wherein the processor is configured to store tile row header information of the tile row in the first memory, wherein the tile row information includes tile row header location data that indicates at least a first memory address of the first memory at which the tile row header information is stored; and store tile row coefficient information of the tile row in the first memory, wherein the tile row information includes tile row coefficient location data that indicates at least a second memory address of the first memory at which the tile row coefficient information is stored.

Example 9 includes the device of Example 8, wherein the tile row header information of the tile row indicates the slice identifier.

Example 10 includes the device of Examples 1 to 9, and further includes a system-on-chip including the processor and on-chip memory, the system-on-chip coupled to off-chip memory, wherein the off-chip memory includes the first memory.

Example 11 includes the device of any of Examples 1 to 10, wherein the processor is configured to selectively, responsive to a determination that a coding tree unit row raster mode is activated, generate the control entry to include the slice identifier.

According to Example 12, a device includes a first memory configured to include a control storage unit associated with an image frame that includes multiple tiles, each of the multiple tiles including a plurality of tile rows of coding units, wherein the control storage unit includes a first control entry indicating first tile row information of a first tile row of a first tile of the multiple tiles, and wherein the first tile row information indicates a first slice identifier of a first slice that includes at least a portion of the first tile row of the first tile; and store first slice information that corresponds to the first slice identifier; and a processor configured to retrieve the first slice identifier from the first control entry stored in the first memory; obtain, based on the retrieved first slice identifier, the first slice information from the first memory; and generate the first tile row of the first tile based at least in part on the first slice information.

Example 13 includes the device of Example 12, further comprising a second memory configured to store a slice information buffer, wherein the processor is further configured to populate, based on one or more control entries of the control storage unit, the slice information buffer to indicate one or more sets of slice information corresponding to one or more slice identifiers that are indicated in the one or more control entries.

Example 14 includes the device of Example 13, wherein: the second memory is configured to store a tile identifier buffer, and the processor is further configured to populate, based on the one or more control entries, a slot of the tile identifier buffer to indicate: a first tile identifier of the first tile and one or more first slots of the slice information buffer.

Example 15 includes the device of Example 14, wherein the one or more first slots of the slice information buffer indicate one or more first sets of slice information of one or more first slices, and wherein each of the one or more first slices includes a corresponding portion of the first tile row of the first tile.

Example 16 includes the device is of any of Examples 12 to 15, wherein the first tile row information indicates first tile row header location data, and wherein the processor is further configured to fetch, based on one or more control entries of the control storage unit, one or more sets of tile row header information from the first memory, wherein first tile row header information is retrieved from the first memory using the first tile row header location data.

Example 17 includes the device is of Example 16, wherein: a second memory is configured to store a tile row header information buffer, and the processor is further configured to populate the tile row header information buffer with the one or more sets of tile row header information fetched from the first memory, wherein a first slot of the tile row header information buffer includes the first tile row header information.

Example 18 includes the device of any of Examples 12 to 17, wherein the control storage unit includes a second control entry indicating second tile row information of a first tile row of a second tile of the multiple tiles, wherein the second tile row information indicates a second slice identifier of a second slice that includes at least a portion of the first tile row of the second tile, and wherein the processor is configured to prefetch second slice information from the first memory based on the second slice identifier retrieved from the second control entry stored in the first memory.

Example 19 includes the device of Example 18, wherein the prefetched second slice information reduces delay associated with using the second slice information at a slice boundary between the first tile row of the first tile and the first tile row of the second tile.

Example 20 includes the device of any of Example 18 or Example 19, wherein the processor is configured to generate the first tile row of the second tile based at least in part on the second slice information, and wherein the first tile row of the first tile and the first tile row of the second tile are generated in a first processing pipeline of the processor.

Example 21 includes the device of Example 20, wherein the processor is configured to generate a third tile row and a fourth tile row in a second processing pipeline of the processor concurrently with generating the first tile row of the first tile and the first tile row of the second tile in the first processing pipeline.

Example 22 includes the device of any of Examples 12 to 21, wherein the first control entry complies with an entry format that includes a slice identifier field that indicates the first slice identifier.

Example 23 includes the device of any of Examples 12 to 22, wherein the first control entry complies with an entry format that includes a slice identifier field that indicates the first slice identifier and a count field that indicates a count of one or more additional slices, and wherein each of the first slice and the one or more additional slices includes a corresponding portion of the first tile row of the first tile.

Example 24 includes the device of any of Examples 12 to 22, wherein each of multiple slices, from the first slice to an end slice, includes a corresponding portion of the first tile row of the first tile, and wherein the first control entry complies with an entry format that includes a first slice identifier field that indicates the first slice identifier of the first slice and a second slice identifier field that indicates an end slice identifier of the end slice.

According to Example 25, a method includes receiving, at a device, a bitstream representing multiple tiles of an image frame, each of the multiple tiles including a plurality of tile rows of coding units; processing, at an entropy decoder of the device, the bitstream to determine slice information of a slice that includes at least a portion of a tile row of a tile of the multiple tiles; storing the slice information in a first memory of the device; and, for the tile row, generating a control entry of a control storage unit stored in the first memory of the device, the control entry indicating tile row information, wherein the tile row information indicates a slice identifier of the slice.

Example 26 includes the method of Example 25, further includes retrieving, at a pixel processor of the device, the slice identifier from the control entry stored in the first memory; obtaining, based on the retrieved slice identifier, the slice information from the first memory; and generating, at the pixel processor of the device, the tile row based at least in part on the slice information.

Example 27 includes the method of Example 25 or Example 26, wherein the tile row information indicates the slice identifier of a single slice, and wherein the slice includes at least the tile row.

Example 28 includes the method of Example 25 or Example 26, wherein the tile row information indicates slice identifiers of multiple slices, and wherein each of the multiple slices includes a corresponding portion of the tile row.

According to Example 29, a method includes retrieving, at a pixel processor of a device, a slice identifier from a control entry of a control storage unit included in a first memory, the control storage unit associated with an image frame that includes multiple tiles, wherein each of the multiple tiles includes a plurality of tile rows of coding units, wherein the control entry indicates tile row information of a tile row of a tile of the multiple tiles, and wherein the tile row information includes the slice identifier of a slice that includes at least a portion of the tile row; obtaining, based on the retrieved slice identifier, slice information from the first memory; and generating, at the pixel processor of the device, the tile row based at least in part on the slice information.

Example 30 includes the method of Example 29, wherein the control entry complies with an entry format that includes a slice identifier field that indicates the slice identifier and a count field that indicates a count of one or more additional slices, and wherein each of the slice and the one or more additional slices includes a corresponding portion of the tile row.

According to an Example 31, a non-transitory computer-readable medium includes instructions that, when executed by a processor, cause the processor to receive a bitstream representing multiple tiles of an image frame, each of the multiple tiles including a plurality of tile rows of coding units; process, at an entropy decoder, the bitstream to determine slice information of a slice that includes at least a portion of a tile row of a tile of the multiple tiles; store the slice information in a first memory; and, for the tile row, generate a control entry of a control storage unit included in the first memory, the control entry indicating tile row information, wherein the tile row information indicates a slice identifier of the slice.

According to Example 32, a non-transitory computer-readable medium includes instructions that, when executed by a processor, cause the processor to retrieve, at a pixel processor, a slice identifier from a control entry of a control storage unit included in a first memory, the control storage unit associated with an image frame that includes multiple tiles, wherein each of the multiple tiles includes a plurality of tile rows of coding units, wherein the control entry indicates tile row information of a tile row of a tile of the multiple tiles, and wherein the tile row information includes the slice identifier of a slice that includes at least a portion of the tile row; obtain, based on the retrieved slice identifier, slice information from the first memory; and generate, at the pixel processor, the tile row based at least in part on the slice information.

According to Example 33, an apparatus includes means for storing control entries associated with an image frame; means for receiving a bitstream representing multiple tiles of the image frame, each of the multiple tiles includes a plurality of tile rows of coding units; and means for generating a control entry of the means for storing the control entries, the control entry generated for a tile row of a tile of the multiple tiles, wherein the control entry includes tile row information that indicates a slice identifier of a slice that includes at least a portion of the tile row.

According to Example 34, an apparatus includes means for storing control entries associated with an image frame that includes multiple tiles, each of the multiple tiles including a plurality of tile rows of coding units, wherein the means for storing control entries includes a first control entry indicating first tile row information of a first tile row of a first tile of the multiple tiles, and wherein the first tile row information indicates a first slice identifier of a first slice that includes at least a portion of the first tile row of the first tile; means for storing first slice information that corresponds to the first slice identifier; means for retrieving the first slice identifier from the first control entry; means for obtaining, based on the retrieved first slice identifier, the first slice information from the means for storing the first slice information; and means for generating the first tile row of the first tile based at least in part on the first slice information.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a first memory configured to include a control storage unit associated with an image frame; and
a processor configured to:
receive a bitstream representing multiple tiles of the image frame, each of the multiple tiles including a plurality of tile rows of coding units; and
for a tile row of a tile of the multiple tiles, generate a control entry of the control storage unit, the control entry including tile row information that indicates a slice identifier of a slice that includes at least a portion of the tile row.

2. The device of claim 1, wherein the tile row information indicates the slice identifier of a single slice, and wherein the slice includes at least the tile row.

3. The device of claim 1, wherein the tile row information indicates slice identifiers of multiple slices, and wherein each of the multiple slices includes a corresponding portion of the tile row.

4. The device of claim 1, wherein the control entry complies with an entry format that includes a slice identifier field that indicates the slice identifier.

5. The device of claim 1, wherein the control entry complies with an entry format that includes a slice identifier field that indicates the slice identifier and a count field that indicates a count of one or more additional slices, and wherein each of the slice and the one or more additional slices includes a corresponding portion of the tile row.

6. The device of claim 1, wherein each of multiple slices, from the slice to an end slice, includes a corresponding portion of the tile row, and wherein the control entry complies with an entry format that includes a first slice identifier field that indicates the slice identifier of the slice and a second slice identifier field that indicates an end slice identifier of the end slice.

7. The device of claim 1, wherein the control entry complies with an entry format that has a 32 byte length, and wherein the entry format includes:
a slice identifier field that indicates the slice identifier;
a tile row header location data field that includes tile row header location data, wherein the tile row header location data field includes a header memory address field and a header size field; and
a tile row coefficient location data field that includes tile row coefficient location data, wherein the tile row coefficient location data field includes a coefficient memory address field and a coefficient size field.

8. The device of claim 1, wherein the processor is configured to:
store tile row header information of the tile row in the first memory, wherein the tile row information includes tile row header location data that indicates at least a first memory address of the first memory at which the tile row header information is stored; and
store tile row coefficient information of the tile row in the first memory, wherein the tile row information includes tile row coefficient location data that indicates at least a second memory address of the first memory at which the tile row coefficient information is stored.

9. The device of claim 8, wherein the tile row header information of the tile row indicates the slice identifier.

10. The device of claim 1, further comprising a system-on-chip including the processor and on-chip memory, the system-on-chip coupled to off-chip memory, wherein the off-chip memory includes the first memory.

11. The device of claim 1, wherein the processor is configured to selectively, responsive to a determination that a coding tree unit row raster mode is activated, generate the control entry to include the slice identifier.

12. A device comprising:
a first memory configured to:
include a control storage unit associated with an image frame that includes multiple tiles, each of the multiple tiles including a plurality of tile rows of coding units, wherein the control storage unit includes a first control entry indicating first tile row information of a first tile row of a first tile of the multiple tiles, and wherein the first tile row information indicates a first slice identifier of a first slice that includes at least a portion of the first tile row of the first tile; and
store first slice information that corresponds to the first slice identifier; and
a processor configured to:
retrieve the first slice identifier from the first control entry included in the first memory;
obtain, based on the retrieved first slice identifier, the first slice information from the first memory; and
generate the first tile row of the first tile based at least in part on the first slice information.

13. The device of claim 12, further comprising a second memory configured to store a slice information buffer, wherein the processor is further configured to populate, based on one or more control entries of the control storage unit, the slice information buffer to indicate one or more sets of slice information corresponding to one or more slice identifiers that are indicated in the one or more control entries.

14. The device of claim 13, wherein:
the second memory is configured to store a tile identifier buffer, and
the processor is further configured to populate, based on the one or more control entries, a slot of the tile identifier buffer to indicate: a first tile identifier of the first tile and one or more first slots of the slice information buffer.

15. The device of claim 14, wherein the one or more first slots of the slice information buffer indicate one or more first sets of slice information of one or more first slices, and wherein each of the one or more first slices includes a corresponding portion of the first tile row of the first tile.

16. The device is of claim 12, wherein the first tile row information indicates first tile row header location data, and wherein the processor is further configured to fetch, based on one or more control entries of the control storage unit, one or more sets of tile row header information from the first memory, wherein first tile row header information is retrieved from the first memory using the first tile row header location data.

17. The device is of claim 16, wherein:
a second memory is configured to store a tile row header information buffer, and
the processor is further configured to populate the tile row header information buffer with the one or more sets of tile row header information fetched from the first memory, wherein a first slot of the tile row header information buffer includes the first tile row header information.

18. The device of claim 12, wherein the control storage unit includes a second control entry indicating second tile row information of a first tile row of a second tile of the multiple tiles, wherein the second tile row information indicates a second slice identifier of a second slice that includes at least a portion of the first tile row of the second tile, and wherein the processor is configured to prefetch second slice information from the first memory based on the second slice identifier retrieved from the second control entry stored in the first memory.

19. The device of claim 18, wherein the prefetched second slice information reduces delay associated with using the second slice information at a slice boundary between the first tile row of the first tile and the first tile row of the second tile.

20. The device of claim 18, wherein the processor is configured to generate the first tile row of the second tile based at least in part on the second slice information, and wherein the first tile row of the first tile and the first tile row of the second tile are generated in a first processing pipeline of the processor.

21. The device of claim 20, wherein the processor is configured to generate a third tile row and a fourth tile row in a second processing pipeline of the processor concurrently with generating the first tile row of the first tile and the first tile row of the second tile in the first processing pipeline.

22. The device of claim 12, wherein the first control entry complies with an entry format that includes a slice identifier field that indicates the first slice identifier.

23. The device of claim 12, wherein the first control entry complies with an entry format that includes a slice identifier field that indicates the first slice identifier and a count field that indicates a count of one or more additional slices, and wherein each of the first slice and the one or more additional slices includes a corresponding portion of the first tile row of the first tile.

24. The device of claim 12, wherein each of multiple slices, from the first slice to an end slice, includes a corresponding portion of the first tile row of the first tile, and wherein the first control entry complies with an entry format that includes a first slice identifier field that indicates the first slice identifier of the first slice and a second slice identifier field that indicates an end slice identifier of the end slice.

25. A method comprising:
receiving, at a device, a bitstream representing multiple tiles of an image frame, each of the multiple tiles including a plurality of tile rows of coding units;
processing, at an entropy decoder of the device, the bitstream to determine slice information of a slice that includes at least a portion of a tile row of a tile of the multiple tiles;
storing the slice information in a first memory of the device; and
for the tile row, generating a control entry of a control storage unit included in the first memory of the device, the control entry indicating tile row information, wherein the tile row information indicates a slice identifier of the slice.

26. The method of claim 25, further comprising:
retrieving, at a pixel processor of the device, the slice identifier from the control entry stored in the first memory;
obtaining, based on the retrieved slice identifier, the slice information from the first memory; and
generating, at the pixel processor of the device, the tile row based at least in part on the slice information.

27. The method of claim 25, wherein the tile row information indicates the slice identifier of a single slice, and wherein the slice includes at least the tile row.

28. The method of claim 25, wherein the tile row information indicates slice identifiers of multiple slices, and wherein each of the multiple slices includes a corresponding portion of the tile row.

29. A method comprising:
retrieving, at a pixel processor of a device, a slice identifier from a control entry of a control storage unit included in a first memory, the control storage unit associated with an image frame that includes multiple tiles, wherein each of the multiple tiles includes a plurality of tile rows of coding units, wherein the control entry indicates tile row information of a tile row of a tile of the multiple tiles, and wherein the tile row information includes the slice identifier of a slice that includes at least a portion of the tile row;
obtaining, based on the retrieved slice identifier, slice information from the first memory; and
generating, at the pixel processor of the device, the tile row based at least in part on the slice information.

30. The method of claim 29, wherein the control entry complies with an entry format that includes a slice identifier field that indicates the slice identifier and a count field that indicates a count of one or more additional slices, and wherein each of the slice and the one or more additional slices includes a corresponding portion of the tile row.
